(19) United States
(12) Patent Application Publication
(10) Pub. No.: US 2023/0341289 A1
(43) Pub. Date: Oct. 26, 2023

(54) Measurement Method, Measurement Device, Measurement System, And Non-Transitory Computer-Readable Storage Medium Storing Measurement Program

(71) Applicant: SEIKO EPSON CORPORATION, Tokyo (JP)

(72) Inventor: Yoshihiro KOBAYASHI, Komagane (JP)

(21) Appl. No.: 18/305,666

(22) Filed: Apr. 24, 2023

(30) Foreign Application Priority Data
Apr. 25, 2022 (JP) 2022-071398

(51) Int. Cl. G01M 5/00

(52) U.S. Cl. CPC G01M 5/0008; G01M 5/005

(57) ABSTRACT

A measurement method includes generating first displacement data based on data of observation points of a structural object, generating observation information, calculating deflection amounts of the structural object by vehicles of a moving object, calculating approach times and exit times of the vehicles with respect to the structural object, calculating time intervals divided by a plurality of times obtained by sorting the approach times and the exit times by time, calculating an amplitude amount of the first displacement data in each of the time intervals, calculating an amplitude amount of the deflection amount in each of the time intervals, and calculating weighting coefficients assuming that a sum of products of the amplitude amounts of the deflection amounts in the time intervals and the weighting coefficients to the vehicles is equal to the amplitude amount of the first displacement data in the time intervals.

The present application is based on, and claims priority from JP Application Serial Number 2022-071398, filed Apr. 25, 2022, the disclosure of which is hereby incorporated by reference herein in its entirety.

### BACKGROUND

### 1. Technical Field

The present disclosure relates to a measurement method, a measurement device, a measurement system, and a non-transitory computer-readable storage medium storing a measurement program.

### 2. Related Art

In JP-2018-31187 (Document 1), there is described a structure performance examination method of a railroad bridge characterized in formulating a theoretical analysis model of a dynamic response of the railroad bridge on which a train is running assuming the train as an array of moving loads and the bridge as a simple beam, and measuring the acceleration of the bridge on which the train is running, and thus, estimating an unknown parameter of the theoretical analysis model from data of the acceleration using an inverse analysis method. More specifically, in the structure performance examination method described in Document 1, an error term is introduced into the theoretical analysis model to define a probability model, a co-occurrence probability that the acceleration data are generated when assuming the unknown parameter as a datum, and an anterior probability density function of the unknown parameter are substituted in a formula obtained by the Bayes' theorem to thereby define a simultaneous posterior probability density function of the unknown parameter when assuming the acceleration data as data, and thus, the structure performance of the railroad bridge is evaluated by reflecting the parameter thus estimated and an uncertainty of that parameter.

When transmitting the acceleration data obtained by the acceleration sensor installed in the bridge to a host via a communication network, the data communication traffic becomes huge, and therefore, it is preferable to adopt a system in which a measurement device installed near the acceleration sensor obtains the acceleration data to perform data processing, and then transmits the measurement data obtained by performing the data processing to the host. Due to such a system configuration, it becomes possible to reduce the data communication traffic to thereby realize reduction in cost of the system as a whole. However, in the method of estimating the unknown parameter of the theoretical analysis model from the acceleration data using the inverse analysis method as in the structure performance examination method described in Document 1, since a calculation amount is extremely large, a measurement device which is expensive and high in performance is required, and thus, it is difficult to realize sufficient reduction in cost of the system as a whole.

### SUMMARY

A measurement method according to an aspect of the present disclosure includes a displacement data generation step of generating first displacement data based on a physical quantity as a response to an action on observation points in a plurality of regions of a moving object moving on a structural object based on data output from an observation device configured to observe the observation points of the structural object, an observation information generation step of generating observation information including an approach time and an exit time of the moving object with respect to the structural object, a vehicle deflection amount calculation step of calculating a deflection amount of the structural object by vehicles of the moving object based on an approximation formula of a deflection of the structural object, the observation information, and environmental information including a dimension of the moving object and a dimension of the structural object generated in advance, a vehicle approach/exit time calculation step of calculating an approach time and an exit time of each of the vehicles of the moving object with respect to the structural object based on the observation information and the environmental information, a time interval calculation step of calculating time intervals divided by a plurality of times obtained by sorting the approach times and the exit times of the vehicles with respect to the structural object by time, a time interval displacement calculation step of calculating an amplitude amount of the first displacement data in each of the time intervals, a time interval deflection amount calculation step of calculating an amplitude amount of the deflection amount of the structural object by each of the vehicles in each of the time intervals, and a weighting coefficient calculation step of calculating weighting coefficients to the respective vehicles assuming that a sum of products of the amplitude amounts of the deflection amounts of the structural object by the vehicles in the time intervals and the weighting coefficients to the vehicles is equal to the amplitude amount of the first displacement data in the respective time intervals.

A measurement device according to an aspect of the present disclosure includes a displacement data generator configured to generate first displacement data based on a physical quantity as a response to an action on observation points in a plurality of regions of a moving object moving on a structural object based on data output from an observation device configured to observe the observation points of the structural object, an observation information generator configured to generate observation information including an approach time and an exit time of the moving object with respect to the structural object, a vehicle deflection amount calculator configured to calculate a deflection amount of the structural object by vehicles of the moving object based on an approximation formula of a deflection of the structural object, the observation information, and environmental information including a dimension of the moving object and a dimension of the structural object generated in advance, a vehicle approach/exit time calculator configured to calculate an approach time and an exit time of each of the vehicles of the moving object with respect to the structural object based on the observation information and the environmental information, a time interval calculator configured to calculate time intervals divided by a plurality of times obtained by sorting the approach times and the exit times of the vehicles with respect to the structural object by time, a time interval displacement calculator configured to calculate an amplitude amount of the first displacement data in each of the time intervals, a time interval deflection amount calculator configured to calculate an amplitude amount of the deflection amount of the structural object by each of the vehicles in each of the time intervals, and a weighting coefficient calculator configured to calculate weighting coefficients to the respective vehicles assuming that a sum of products of the amplitude amounts of the deflection amounts of the structural object by the vehicles in the time intervals and the weighting coefficients to the vehicles is equal to the amplitude amount of the first displacement data in the respective time intervals.

A measurement system according to another aspect of the present disclosure includes the measurement device according to the aspect, and the observation device configured to observe the observation points.

A non-transitory computer-readable storage medium storing a measurement program according to an aspect of the present disclosure makes a computer execute a displacement data generation step of generating first displacement data based on a physical quantity as a response to an action on observation points in a plurality of regions of a moving object moving on a structural object based on data output from an observation device configured to observe the observation points of the structural object, an observation information generation step of generating observation information including an approach time and an exit time of the moving object with respect to the structural object, a vehicle deflection amount calculation step of calculating a deflection amount of the structural object by vehicles of the moving object based on an approximation formula of a deflection of the structural object, the observation information, and environmental information including a dimension of the moving object and a dimension of the structural object generated in advance, a vehicle approach/exit time calculation step of calculating an approach time and an exit time of each of the vehicles of the moving object with respect to the structural object based on the observation information and the environmental information, a time interval calculation step of calculating time intervals divided by a plurality of times obtained by sorting the approach times and the exit times of the vehicles with respect to the structural object by time, a time interval displacement calculation step of calculating an amplitude amount of the first displacement data in each of the time intervals, a time interval deflection amount calculation step of calculating an amplitude amount of the deflection amount of the structural object by each of the vehicles in each of the time intervals, and a weighting coefficient calculation step of calculating weighting coefficients to the respective vehicles assuming that a sum of products of the amplitude amounts of the deflection amounts of the structural object by the vehicles in the time intervals and the weighting coefficients to the vehicles is equal to the amplitude amount of the first displacement data in the respective time intervals.

### BRIEF DESCRIPTION OF THE DRAWINGS

FIG. 1 is a diagram showing a configuration example of a measurement system.

FIG. 2 is a cross-sectional view of an upper structure shown in FIG. 1 cut along the line A-A.

FIG. 3 is an explanatory diagram of acceleration detected by an acceleration sensor.

FIG. 4 is a diagram showing an example of displacement data u(t).

FIG. 5 is a diagram showing an example of displacement data uₗₚ(t).

FIG. 6 is a diagram showing an example of velocity data vₗₚ(t).

FIG. 7 is a diagram showing an example of a relationship between the displacement data u(t), and an approach time tᵢ and an exit time tₒ.

FIG. 8 is a diagram showing an example of a length L_{c}(Cₘ) of a vehicle and a distance La(a_{w}(Cₘ,n)) between axles.

FIG. 9 is an explanatory diagram of a structure model of an upper structure of a bridge.

FIG. 10 is a diagram showing an example of a deflection amount w_{std}(a_{w}(Cₘ,n),t).

FIG. 11 is a diagram showing an example of a deflection amount C_{std}(Cₘ,t).

FIG. 12 is a diagram showing an example of a deflection amount T_{std}(t).

FIG. 13 is a diagram showing an example of a relationship between the displacement data u(t) and times tsort(1) through tsort(2C_{T}).

FIG. 14 is a diagram showing an example of amplitude amounts u_{M}(n) of the displacement data u(t) in time intervals tₙ.

FIG. 15 is a diagram showing an example of weights of 1-st through C_{T}-th vehicles calculated from weighting coefficients P₁ through P_{CT}.

FIG. 16 is a diagram showing an example of a deflection amount T_{p_std}(t).

FIG. 17 is a diagram showing an example of a deflection amount T_{p_std_1}p(t).

FIG. 18 is a diagram showing the displacement data uₗₚ(t) and the deflection amount T_{p_std_lp}(t) in an overlapping manner.

FIG. 19 is a diagram showing an example of a deflection amount T_{p_std_lp}(t).

FIG. 20 is a diagram showing an example of a deflection amount T_{p_Estd}(t).

FIG. 21 is a diagram showing an example of a relationship between the deflection amount T_{p_Estd_lp}(t) and the deflection amount T_{p_std_lp}(t), and a predetermined interval T_{avg} for calculating respective average values of the deflection amounts.

FIG. 22 is a diagram showing an example of an offset T_{p_offset_std}(t).

FIG. 23 is a diagram showing an example of a deflection amount T_{p_EOstd}(t).

FIG. 24 is a diagram showing a relationship between the displacement data u(t) and the deflection amount T_{p_EOstd}(t).

FIG. 25 is a flowchart showing an example of a procedure of a measurement method according to a first embodiment.

FIG. 26 is a flowchart showing an example of a procedure of a displacement data generation step.

FIG. 27 is a flowchart showing an example of a procedure of an observation information generation step.

FIG. 28 is a flowchart showing an example of a procedure of an average velocity calculation step.

FIG. 29 is a flowchart showing an example of a procedure of a vehicle deflection amount calculation step.

FIG. 30 is a flowchart showing an example of a procedure of a vehicle approach/exit time calculation step.

FIG. 31 is a flowchart showing an example of a procedure of a static response calculation step.

FIG. 32 is a diagram showing a configuration example of a sensor, a measurement device, and a monitoring device.

FIG. 33 is a diagram showing an example of a deflection amount C_{p_std_tsort}(n,Cₘ,t).

FIG. 34 is a diagram showing another example of the deflection amounts C_{std}(Cₘ,t), T_{std}(t).

FIG. 35 is a diagram showing another example of the deflection amounts C_{std}(Cₘ,t), T_{std}(t).

FIG. 36 is a diagram showing another example of the deflection amounts C_{std}(Cₘ,t), T_{std}(t).

FIG. 37 is a diagram showing another example of the deflection amounts C_{std}(Cₘ,t), T_{std}(t).

FIG. 38 is a diagram showing another example of the deflection amounts C_{std}(Cₘ,t), T_{std}(t).

FIG. 39 is a diagram showing another example of the deflection amounts C_{std}(Cₘ,t), T_{std}(t).

FIG. 40 is a diagram showing another example of the deflection amounts C_{std}(Cₘ,t), T_{std}(t).

FIG. 41 is a flowchart showing an example of a procedure of a measurement method according to a second embodiment.

FIG. 42 is a diagram showing a configuration example of a measurement device according to the second embodiment.

FIG. 43 is a diagram showing another configuration example of the measurement system.

FIG. 44 is a diagram showing another configuration example of the measurement system.

FIG. 45 is a diagram showing another configuration example of the measurement system.

FIG. 46 is a cross-sectional view of an upper structure shown in FIG. 45 cut along the line A-A.

### DESCRIPTION OF EXEMPLARY EMBODIMENTS

Some preferred embodiments of the present disclosure will hereinafter be described in detail using the drawings. It should be noted that the embodiments described below do not unreasonably limit the content of the present disclosure as set forth in the appended claims. Further, all of the constituents described below are not necessarily essential elements of the present disclosure.

### 1. Embodiment

### 1-1. Configuration of Measurement System

A moving object passing through an upper structure of a bridge as a structural object according to the present embodiment is a vehicle or a railroad vehicle which is heavy in weight and can be measured with BWIM. BMIM is an abbreviation for Bridge Weight in Motion, and is a technology of measuring the weight, the number of axles, and so on of the moving object passing through the bridge by likening the bridge to a “scale,” and measuring a deformation of the bridge. The upper structure of the bridge which is capable of analyzing the weight of the moving object which passes through the bridge based on a response such as the deformation or a strain is a structure in which BWIM works, and a BWIM system applying a physical process between an action to the upper structure of the bridge and a response makes it possible to measure the weight of the moving object which passes through the bridge. A measurement system for realizing a measurement method according to the present embodiment will hereinafter be described citing the case in which the moving object is the railroad vehicle as an example.

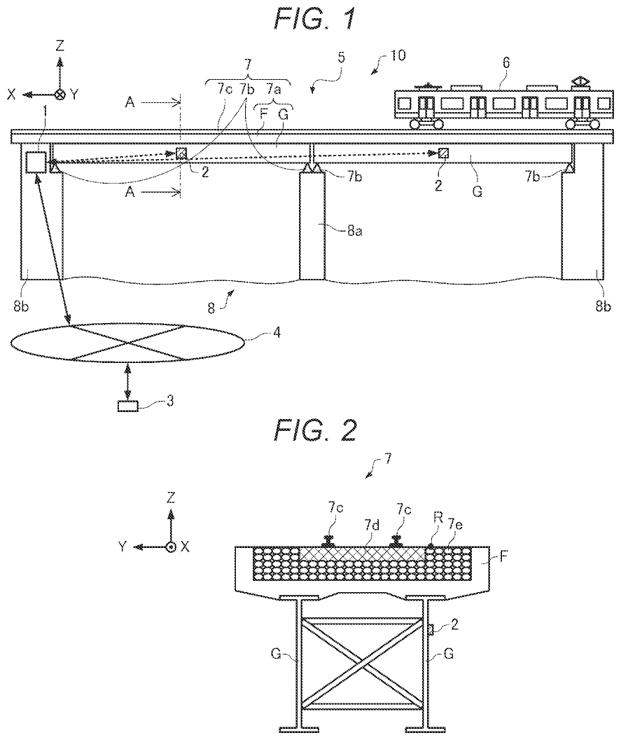

FIG. 1 is a diagram showing an example of the measurement system according to the present embodiment. As shown in FIG. 1, the measurement system 10 according to the present embodiment is provided with a measurement device 1, and at least one sensor 2 provided to an upper structure 7 of a bridge 5. Further, the measurement system 10 can be provided with a monitoring device 3.

The bridge 5 is constituted by the upper structures 7 and a lower structure 8. FIG. 2 is a cross-sectional view of the upper structure 7 cut along the line A-A shown in FIG. 1. As shown in FIG. 1 and FIG. 2, the upper structure 7 includes a bridge floor 7a constituted by a floor plate F, main beams G, side beams not shown, and so on, shoes 7b, rails 7c, railroad ties 7d, and ballast 7e. Further, as shown in FIG. 1, the lower structure 8 includes bridge legs 8a and bridge abutments 8b. The upper structure 7 is a structure bridged between any one of pairs of the bridge abutment 8b and the bridge leg 8a adjacent to each other, the bridge abutments 8b adjacent to each other, and the bridge legs 8a adjacent to each other. Both end portions of the upper structure 7 are located at positions of the bridge abutment 8b and the bridge leg 8a adjacent to each other, positions of the two bridge abutments 8b adjacent to each other, or positions of the two bridge legs 8a adjacent to each other.

When the railroad vehicle 6 approaches the upper structure 7, the upper structure 7 is deflected due to the weight of the railroad vehicle 6, but the railroad vehicle 6 has a plurality of vehicles coupled to each other, and therefore, there occurs a phenomenon that the deflection of the upper structure 7 is periodically repeated in accordance with the passage of the vehicles. This phenomenon is called a static response. In contrast, since the upper structure 7 has a natural resonance frequency as a structural object, by the railroad vehicle 6 passing through the upper structure 7, the natural vibration of the upper structure 7 is excited in some cases. By the natural vibration of the upper structure 7 being excited, there occurs a phenomenon that the deflection of the upper structure 7 is periodically repeated. This phenomenon is called a dynamic response.

The measurement device 1 and the sensors 2 are coupled to each other with, for example, cables not shown, and perform communication via a communication network such as CAN. CAN is an abbreviation for Controller Area Network. Alternatively, it is possible for the measurement device 1 and the sensors 2 to perform the communication via a wireless network.

Each of the sensors 2 outputs data to be used for calculating the static response when the railroad vehicle 6 as a moving object moves on the upper structure 7 as a structural object. In the present embodiment, the sensors 2 are each an acceleration sensor, and can also be, for example, a quartz crystal acceleration sensor or an MEMS acceleration sensor. MEMS is an abbreviation for Micro Electro Mechanical Systems.

In the present embodiment, the sensors 2 are each installed in a central portion in the longitudinal direction of the upper structure 7, specifically a central portion in the longitudinal direction of the main beam G. It should be noted that it is sufficient for each of the sensors 2 to be able to detect the acceleration for calculating the static response, and the installation position is not limited to the central portion of the upper structure 7. It should be noted that when each of the sensors 2 is installed on the floor plate F of the upper structure 7, there is a possibility that the sensor 2 is broken due to running of the railroad vehicle 6, and further, there is a possibility that the measurement accuracy is affected by a local deformation of the bridge floor 7a, and therefore, in the example shown in FIG. 1 and FIG. 2, each of the sensors 2 is provided to the main beam G of the upper structure 7.

The floor plate F, the main beam G, and so on of the upper structure 7 are deflected in a vertical direction due to the load by the railroad vehicle 6 passing through the upper structure 7. Each of the sensors 2 detects the acceleration of the deflection of the floor plate F and the main beam G due to the load by the railroad vehicle 6 passing through the upper structure 7.

The measurement device 1 calculates the static response when the railroad vehicle 6 passes through the upper structure 7 based on the acceleration data output from each of the sensors 2. The measurement device 1 is installed in, for example, the bridge abutment 8b.

The measurement device 1 and the monitoring device 3 are capable of communicating with each other via a communication network 4 such as a wireless network of cellular phones or the Internet. The measurement device 1 transmits the measurement data including the static response when the railroad vehicle 6 passes through the upper structure 7 to the monitoring device 3. It is possible for the monitoring device 3 to store that information in a storage device not shown, and perform processing such as monitoring of the railroad vehicle 6 and a failure determination of the upper structure 7 based on that information.

It should be noted that in the present embodiment, the bridge 5 is a railroad bridge, and for example, a steel bridge, a beam bridge, or an RC bridge. RC is an abbreviation for Reinforced-Concrete.

As shown in FIG. 2, in the present embodiment, a observation point R is set in association with the sensor 2. In the example shown in FIG. 2, the observation point R is set at a position on a surface of the upper structure 7 located at a vertically upward direction side of the sensor 2 provided to the main beam G. In other words, the sensor 2 is an observation device for observing the observation point R, detects physical quantities as responses to actions to the observation points R in a plurality of regions of the railroad vehicle 6 which moves on the upper structure 7 as a structural object, and then outputs data including the physical quantities thus detected. For example, each of the plurality of regions of the railroad vehicle 6 is an axle or a wheel, but is hereinafter assumed to be the axle. Further, in the present embodiment, each of the sensors 2 is an acceleration sensor, and detects the acceleration as the physical quantity. It is sufficient for the sensor 2 to be disposed at a position where sensor 2 can detect the acceleration occurring at the observation point R due to the running of the railroad vehicle 6, but it is desirable for the sensor 2 to be disposed at a position close to an area vertically above the observation point R.

It should be noted that the number and the installation positions of the sensors 2 are not limited to those of the example shown in FIG. 1 and FIG. 2, and a variety of modified implementations can be made.

The measurement device 1 obtains the acceleration in a direction crossing the surface of the upper structure 7 on which the railroad vehicle 6 moves based on the acceleration data output from the sensors 2. The surface of the upper structure 7 on which the railroad vehicle 6 moves is defined by a direction in which the railroad vehicle 6 moves, namely an X direction as a longitudinal direction of the upper structure 7, and a direction perpendicular to the direction in which the railroad vehicle 6 moves, namely a Y direction as a width direction of the upper structure 7. Due to the running of the railroad vehicle 6, the observation point R is deflected in a direction perpendicular to the X direction and the Y direction, and therefore, it is desirable for the measurement device 1 to obtain the acceleration in a direction perpendicular to the X direction and the Y direction, namely a Z direction as a normal direction of the floor plate F in order to accurately calculate the magnitude of the acceleration of the deflection.

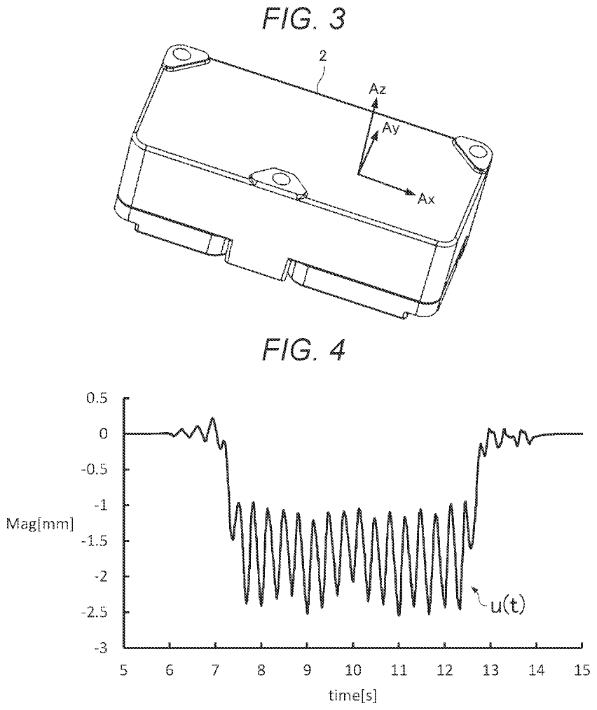

FIG. 3 is a diagram for explaining the acceleration to be detected by the sensor 2. The sensor 2 is an acceleration sensor for detecting the acceleration generated in each of axial directions of the three axes perpendicular to each other.

In order to detect the acceleration of the deflection of the observation point R due to the running of the railroad vehicle 6, the sensor 2 is installed so that one of an x axis, a y axis, and a z axis as three detection axes becomes a direction crossing the X direction and the Y direction. In FIG. 1 and FIG. 2, the sensor 2 is installed so that one of the axes becomes in a direction crossing the X direction and the Y direction. Since the observation point R is deflected in the direction perpendicular to the X direction and the Y direction, in order to accurately detect the acceleration of the deflection, ideally, the sensor 2 is installed so that one of the axes coincides with the Z direction perpendicular to the X direction and the Y direction, namely the normal direction of the floor plate F.

It should be noted that when installing the sensor 2 in the upper structure 7, the installation place is tilted in some cases. In the measurement device 1, the error is negligibly small since one of the three detection axes of the sensor 2 is substantially oriented to the normal direction of the floor plate F even when the sensor 2 is not installed so that one of the three detection axes of the sensor 2 coincides with the normal direction of the floor plate F. Further, even when the sensor 2 is not installed so that one of the three detection axes coincides with the normal direction of the floor plate F, it is possible for the measurement device 1 to perform the correction of the detection error due to the tilt of the sensor 2 using three-axis resultant acceleration obtained by combining the acceleration in the x axis, the acceleration in the y axis, and the acceleration in the z axis with each other. Further, the sensor 2 can be a single-axis acceleration sensor for detecting at least acceleration generated in a direction substantially parallel to a vertical direction, or acceleration in the normal direction of the floor plate F.

The details of the measurement method according to the present embodiment executed by the measurement device 1 will hereinafter be described.

### 1-2. Details of Measurement Method

First, the measurement device 1 integrates acceleration data a(k) output from the sensor 2 as the acceleration sensor to generate velocity data v(k) as expressed in Formula (1), and further, integrates the velocity data v(k) to generate displacement data u(k) as expressed in Formula (2). The acceleration data a(k) are data of an acceleration variation obtained by removing an acceleration bias which is unnecessary to calculate a displacement variation when the railroad vehicle 6 passes through the bridge 5. For example, it is possible to assume the acceleration immediately before the railroad vehicle 6 passes through the bridge 5 as 0, and assume the subsequent acceleration variation as the acceleration data a(k). In Formula (1) and Formula (2), k is a sample number, and ΔT is a time interval between samples. The displacement data u(k) are data of the displacement of the observation point R by the running of the railroad vehicle 6.

v(k)=α(k)ΔT+v(k−1) (1)

u(k)=v(k)ΔT+u(k−1) (2)

The displacement data u(k) using the sample number k as a variable are converted into displacement data u(t) using the time t as a variable when t=kΔT is assumed. FIG. 4 shows an example of the displacement data u(t). The displacement data u(t) are generated based on the acceleration data a(t) output from the sensor 2 for observing the observation point R, and are therefore data based on the acceleration as a response to actions on the observation points R of a plurality of axles of the railroad vehicle 6 moving on the upper structure 7.

Then, in order to reduce a vibration component with a basic frequency fᵤ₍ₜ₎ and a harmonic wave of the vibration component included in the displacement data u(t), the measurement device 1 generates the displacement data uₗₚ(t) obtained by performing filter processing on the displacement data u(t). The filter processing can be, for example, a lowpass filter processing, and can also be a bandpass filter processing.

Specifically, first, the measurement device 1 performs fast Fourier transformation processing on the displacement data u(t) to calculate the power spectral density, and calculates a peak of the power spectral density as the basic frequency fᵤ₍ₜ₎. Further, the measurement device 1 calculates a moving average interval t_{MA} from the time interval ΔT and the basic frequency fᵤ₍ₜ₎ of the samples of the displacement data u(t) using Formula (3).

$${t}_{MA} = \frac{Δ T}{2} ⌈ \frac{1}{Δ T {f}_{u ( t )}} ⌉ \qquad ( 3 )$$

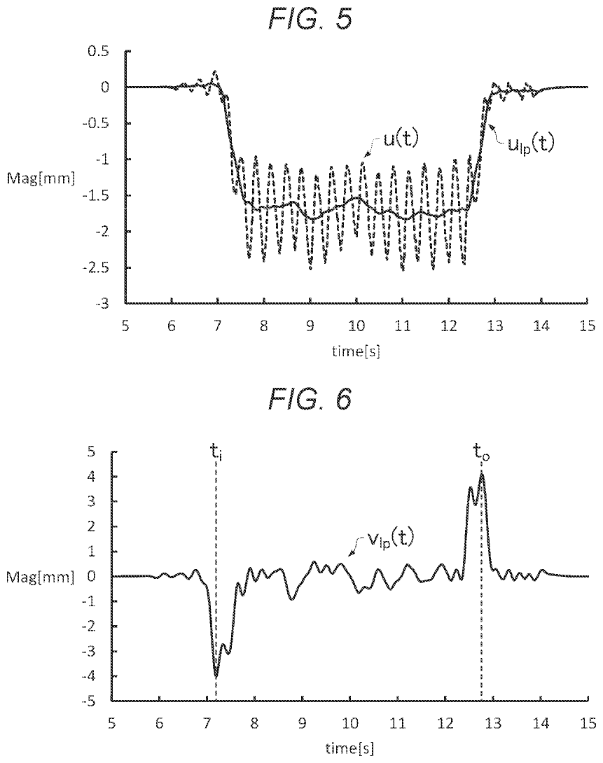

Then, as the filter processing, the measurement device 1 performs moving average processing on the displacement data u(t) using Formula (4) to generate the displacement data uₗₚ(t) obtained by reducing the vibration component included in the displacement data u(t). Since the moving average processing is not only small in necessary calculation amount, but also extremely large in attenuation amounts of the signal component of the basic frequency fᵤ₍ₜ₎ and the harmonic component thereof, it is possible to obtain the displacement data uₗₚ(t) in which the vibration component is effectively reduced. FIG. 5 shows an example of the displacement data uₗₚ(t). As shown in FIG. 5, it is possible to obtain the displacement data uₗₚ(t) in which most of the vibration component included in the displacement data u(t) is removed.

$${u}_{lp} ( t ) = \frac{1}{2 {t}_{MA} + Δ T} {\sum }_{k = t - {t}_{MA}}^{k + {t}_{MA}} u ( k ) \qquad ( 4 )$$

It should be noted that it is possible for the measurement device 1 to perform FIR filter processing of attenuating signal components with frequencies no lower than the basic frequency fᵤ₍ₜ₎ on the displacement data u(t) as the filter processing to thereby generate the displacement data uₗₚ(t). FIR is an abbreviation for Finite Impulse Response. The FIR filter processing is larger in calculation amount than the moving average processing, but is capable of attenuating all of the signal components having frequencies no lower than the basic frequency fᵤ₍ₜ₎.

Then, the measurement device 1 calculates an approach time tᵢ and an exit time tₒ of the railroad vehicle 6 with respect to the upper structure 7 from the displacement data uₗₚ(t). Specifically, first, the measurement device 1 differentiates the displacement data uₗₚ(t) to calculate velocity data vₗₚ(t) as expressed in Formula (5). FIG. 6 shows an example of the velocity data Vₗₚ(t).

$${v}_{lp} ( t ) = \frac{{u}_{l p} ( t )}{Δ T} + v ( t - Δ T ) \qquad ( 5 )$$

Then, as shown in FIG. 6, the measurement device 1 calculates a time of a peak in a negative value range in the velocity data vₗₚ(t) as the approach time tᵢ, and calculates a time of a peak in a positive value range in the velocity data vₗₚ(t) as the exit time to.

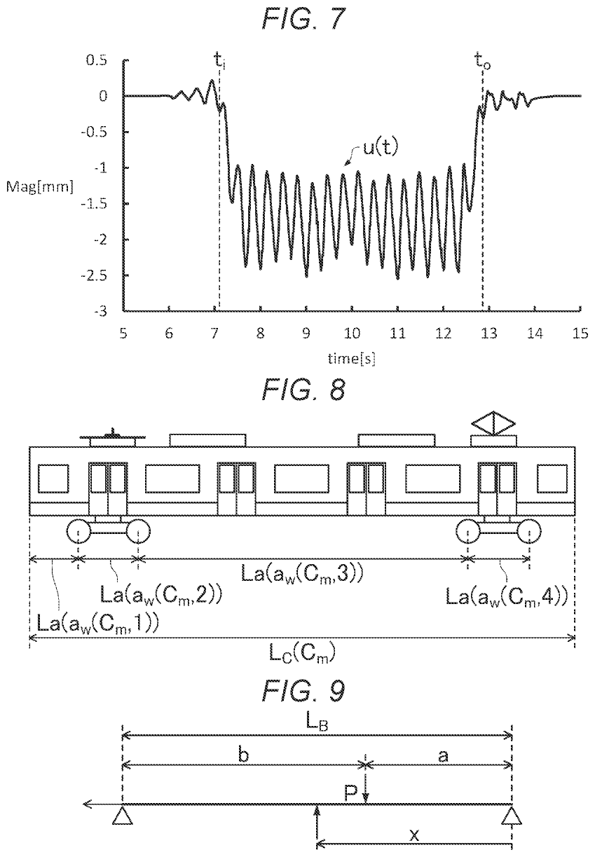

The approach time tᵢ is the time when first one of the plurality of axles of the railroad vehicle 6 passes an approach end of the upper structure 7. Further, the exit time tₒ is the time when rearmost one of the plurality of axles of the railroad vehicle 6 passes an exit end of the upper structure 7. FIG. 7 shows an example of a relationship between the displacement data u(t), and the approach time tᵢ and the exit time to.

Then, the measurement device 1 calculates a passage time tₛ in which the railroad vehicle 6 passes through the upper structure 7 of the bridge 5 as a difference between the exit time tₒ and the approach time tᵢ using Formula (6).

tₛ=t₀−tᵢ (6)

ν=tₛfᵤ₍ₜ₎ (7)

Further, the measurement device 1 calculates a wave number ν of the basic frequency fᵤ₍ₜ₎ included in the passage time tₛ using Formula (7), and then calculates the number of vehicles C_{T} of the railroad vehicle 6 by rounding the wave number ν into a proximate integer as expressed in Formula (8).

C_{T}=round{ν−1} (8)

The measurement device 1 stores observation information including the approach time t₁, the exit time to, the passage time tₛ, and the number of vehicles C_{T} into a storage not shown.

Then, the measurement device 1 performs the following processing based on the observation information and environmental information including dimensions of the railroad vehicle 6 and dimensions of the upper structure 7 prepared in advance.

The environmental information includes, for example, the length L_{B} of the upper structure 7 and the position Lₓ of the observation point R as the dimensions of the upper structure 7. The length L_{B} of the upper structure 7 is a distance between the approach end and the exit end of the upper structure 7. Further, the position Lₓ of the observation point R is a distance from the approach end and the observation point R of the upper structure 7. Further, the environmental information includes, for example, the length L_{c} (Cₘ) of each of the vehicles of the railroad vehicle 6, the number of axles a_{T}(Cₘ) of each of the vehicles, and the distance La(a_{w}(Cₘ,n)) between the axles of each of the vehicles as the dimensions of the railroad vehicle 6. Cₘ denotes a vehicle number, and the length L_{c}(Cₘ) of each of the vehicles represents a distance between both ends of the Cₘ-th vehicle from the head. The number of axles a_{T}(Cₘ) of each of the vehicles represents the number of axles of the Cₘ-th vehicle from the head. The character n represents an axle number of each of the vehicles, and 1≤n≤a_{T}(Cₘ) is fulfilled. The distance La(a_{w}(Cₘ,n)) between the axles of each of the vehicles represents a distance between a tip and a 1-st axle from the head in the Cₘ-th vehicle from the head when n=1 is set, and represents a distance between the (n−1)-th axle from the head and the n-th axle when n fulfills n≥2. FIG. 8 shows an example of the length L_{c}(Cₘ) and the distance La(a_{w}(Cₘ,n)) between the axles of the Cₘ-th vehicle of the railroad vehicle 6. The dimensions of the railroad vehicle 6 and the dimensions of the upper structure 7 can be measured by a method known to the public.

It should be noted that when it is assumed that the railroad vehicle 6 having an arbitrary number of vehicles the same in dimensions coupled to each other runs through the upper structure 7 of the bridge 5, it is sufficient for the environmental information to include the length L_{c}(Cₘ) of the vehicle, the number of axles a_{T}(Cₘ) and the distance La(a_{w}(Cₘ,n)) between the axles for one of the vehicles.

When a plurality of types of railroad vehicles can exist as the railroad vehicle 6 passing through the bridge 5, it is possible for the measurement device 1 to calculate the length of the one vehicle out of the railroad vehicle 6 from, for example, the passage time tₛ and the number of vehicles C_{T} included in the observation information, and then compare the length of the one vehicle thus calculated with the length L_{c}(Cₘ) of each of the vehicles included in the environmental information to identify the type of the railroad vehicle 6. Alternatively, it is possible for the measurement device 1 to identify the type of the railroad vehicle 6 from the passage time of the railroad vehicle 6.

The total number of axles Ta_{T} of the railroad vehicle 6 is calculated by Formula (9) using the number of vehicles C_{T} included in the observation information and the number of axles a_{T}(Cₘ) of each of the vehicles included in the environmental information.

$${Ta}_{T} = {\sum }_{{C}_{m} = 1}^{{C}_{r}} {a}_{T} ( {C}_{m} ) \qquad ( 9 )$$

Since the action of the load by the railroad vehicle 6 to the upper structure 7 propagates via the respective axles, the response when the railroad vehicle 6 passes through the upper structure 7 becomes a response from the head axle to the rearmost axle of the railroad vehicle 6. A distance D_{wa}(a_{w}(Cₘ,n)) from the head axle of the railroad vehicle 6 to the n-th axle of the Cₘ-th vehicle is calculated using Formula (10).

$${D}_{wa} ( {a}_{w} ( {C}_{m} , n ) ) {\sum }_{y = 1}^{{C}_{m} - 1} {L}_{C} ( y ) - La ( {a}_{w} ( 1 , 1 ) ) + {\sum }_{x = 1}^{n} La ( {a}_{w} ( {C}_{m} , x ) ) \qquad ( 10 )$$

Using Formula (11) obtained by substituting Cₘ=C_{T} and n=a_{T}(C_{T}) in Formula (10), the distance D_{wa}(a_{w}(C_{T},a_{T}(C_{T}))) from the head axle to the rearmost axle of the rearmost vehicle of the railroad vehicle 6 is calculated.

$${D}_{wa} ( {a}_{w} ( \text{?} ) ) = \text{?} {L}_{C} ( y ) - La ( {a}_{w} ( 1 , 1 ) ) + \text{?} La ( {a}_{w} ( \text{?} , x ) ) \qquad ( 11 )$$

$$\text{?} \text{indicates text missing or illegible when filed}$$

Average velocity vₐ of the railroad vehicle 6 is calculated by Formula (12) using the length L_{B} of the upper structure 7 included in the environmental information, the passage time tₛ included in the observation information, and the distance D_{wa}(a_{w}(C_{T},a_{T}(C_{T}))) thus calculated.

$${v}_{a} = \frac{1}{{t}_{s}} \{ {L}_{B} + {D}_{wa} ( {a}_{w} ( {C}_{T} , {a}_{T} ( {C}_{T} ) ) ) \} \qquad ( 12 )$$

The measurement device 1 calculates the average velocity vₐ of the railroad vehicle 6 using Formula (13) obtained by substituting Formula (11) in Formula (12).

$${v}_{a} = \frac{1}{{t}_{s}} \{ {L}_{B} + \text{?} {L}_{C} ( {C}_{m} ) - La ( {a}_{w} ( 1 , 1 ) ) + \text{?} La ( {a}_{w} ( \text{?} , x ) ) \} \qquad ( 13 )$$

$$\text{?} \text{indicates text missing or illegible when filed}$$

Then, the measurement device 1 calculates the deflection amount of the upper structure 7 caused by running of the railroad vehicle 6 in the following manner.

In the present embodiment, there is regarded a configuration in which the bridge floor 7a constituted by the floor plate F, the main beam G, and so on is arranged alone, or a plurality of such bridge floors 7a is arranged continuously in the upper structure 7 of the bridge 5, and the measurement device 1 calculates the displacement of one of the bridge floors 7a as the displacement in a central portion in the longitudinal direction. The load to be applied to the upper structure 7 moves from one end of the upper structure 7 to the other end. On this occasion, it is possible to express the deflection amount as the displacement in the central portion of the upper structure 7 using the position of the load on the upper structure 7 and the load amount. In the present embodiment, in order to express the flexural deformation when the axle of the railroad vehicle 6 moves on the upper structure 7 as a trajectory of the deflection amount due to the movement of a point load on the beam, a structure model shown in FIG. 9 is considered, and in that structure model, the deflection amount in the central portion is calculated. In FIG. 9, P represents a load. The character a represents a load position from an approach end of the upper structure 7 at the side to which the railroad vehicle 6 approaches. The character b represents a load position from an exit end of the upper structure 7 at the side from which the railroad vehicle 6 exits. L_{B} represents the length of the upper structure 7, namely the distance between the both ends of the upper structure 7. The structure model shown in FIG. 9 is a simple beam which has fulcrum points at both ends, and which is supported at the both ends.

In the structure model shown in FIG. 9, when defining the position of the approach end of the upper structure 7 as zero, and the observation position of the deflection amount as x, the bending moment M of the simple beam is expressed as Formula (14).

$$M = \frac{b}{{L}_{B}} Px - {PH}_{a} ( x - a ) \qquad ( 14 )$$

In Formula (14), the function Hₐ is defined as Formula (15).

$${H}_{a} = \{ \begin{matrix}0 & ( if x \leq a ) \\ 1 & ( if x > a )\end{matrix} \qquad ( 15 )$$

Formula (14) is modified to obtain Formula (16).

$$- \frac{{ML}_{B}}{P} = - bx + {H}_{a} {L}_{B} ( x - a ) \qquad ( 16 )$$

In contrast, the bending moment M is expressed as Formula (17). In Formula (17), θ represents an angle, I represents a second-order moment, and E represents a Young's modulus.

$$- M = EI \frac{d θ}{dx} \qquad ( 17 )$$

Formula (17) is substituted in Formula (16) to obtain Formula (18).

$$\frac{{EIL}_{B}}{P} \frac{d θ}{dx} = - bx + {H}_{a} {L}_{B} ( x - a ) \qquad ( 18 )$$

By calculating Formula (19) for integrating Formula (18) with respect to the observation position x, Formula (20) can be obtained. In Formula (20), C₁ is an integration constant.

$$\int \frac{{EIL}_{B}}{P} \frac{d θ}{dx} dx = \int ( - bx + {H}_{a} {L}_{B} ( x - a ) ) dx \qquad ( 19 )$$

$$\frac{{EIL}_{B}}{P} θ = - \frac{{bx}^{2}}{2} + {H}_{a} \frac{{{L}_{B} ( x - a )}^{2}}{2} + {C}_{1} \qquad ( 20 )$$

Further, by calculating Formula (21) for integrating Formula (20) with respect to the observation position x, Formula (22) can be obtained. In Formula (22), C₂ is an integration constant.

$$\int \frac{{EIL}_{B}}{P} θ dx = \int \{ - \frac{{bx}^{2}}{2} + {H}_{a} \frac{{{L}_{B} ( x - a )}^{2}}{2} + {C}_{1} \} dx \qquad ( 21 )$$

$$\frac{{EIL}_{B}}{P} θ x = - \frac{{bx}^{3}}{6} + {H}_{a} \frac{{{L}_{B} ( x - a )}^{3}}{6} + {C}_{1} x + {C}_{2} \qquad ( 22 )$$

In Formula (22), ex represents the deflection amount, and by replacing ex with the deflection amount w, Formula (23) can be obtained.

$$\frac{{EIL}_{B}}{P} w = - \frac{{bx}^{3}}{6} + {H}_{a} \frac{{{L}_{B} ( x - a )}^{3}}{6} + {C}_{1} x + {C}_{2} \qquad ( 23 )$$

Since b=L_{B}−a is true as shown in FIG. 9, Formula (23) is deformed into Formula (24).

$$\frac{{EIL}_{B}}{P} w = - \frac{( {L}_{B} - a ) {x}^{3}}{6} + {H}_{a} \frac{{{L}_{B} ( x - a )}^{3}}{6} + {C}_{1} x + {C}_{2} \qquad ( 24 )$$

Assuming the deflection amount w=0 at x=0, since Hₐ=0 is true from x≤a, by substituting x=w=Hₐ=0 in Formula (24) and then coordinating the result, Formula (25) can be obtained.

C₂=0 (25)

Further, assuming the deflection amount w=0 at x=L_{B}, since Hₐ=1 is true from x>a, by substituting x=L_{B}, w=0, and Hₐ=1 in Formula (24) and then coordinating the result, Formula (26) can be obtained.

$${C}_{1} = \frac{a ( {L}_{B} - a ) ( a + 2 ( {L}_{B} - a ) )}{6} \qquad ( 26 )$$

Formula (27) is obtained by substituting b=L_{B}−a in Formula (26).

$${C}_{1} = \frac{ab ( a + 2 b )}{6} \qquad ( 27 )$$

By substituting the integration constant C₁ of Formula (25) and the integration constant C₂ of Formula (26) in Formula (23), Formula (28) can be obtained.

$$\frac{\text{?}}{P} w = - \frac{{bx}^{3}}{6} + {H}_{a} \frac{{{L}_{B} ( x - a )}^{3}}{6} + \frac{ab ( a + 2 b )}{6} x \qquad ( 28 )$$

$$\text{?} \text{indicates text missing or illegible when filed}$$

By modifying Formula (28), the deflection amount w at the observation position x when the load P is applied at the position a is expressed by Formula (29).

$$w = \frac{P}{\text{?}} \{ - {bx}^{3} + {H}_{a} {{L}_{B} ( x - a )}^{3} + ab ( a + 2 b ) x \} \qquad ( 29 )$$

$$\text{?} \text{indicates text missing or illegible when filed}$$

The deflection amount w_{0.5LB} at the central observation position x when the load P is located at the center of the upper structure 7 is expressed as Formula (30) assuming x=0.5L_{B}, a=b=0.5L_{B}, and Hₐ=0. This deflection amount W_{0.5LB} becomes a maximum amplitude of the deflection amount w.

$$\text{?} = \frac{P}{\text{?}} {L}_{B}^{3} \qquad ( 30 )$$

$$\text{?} \text{indicates text missing or illegible when filed}$$

The deflection amount w at an arbitrary observation position x is standardized by the deflection amount w_{0.5LB}. When the position a of the load P is located at the approach end side of the observation position x, Hₐ=1 is substituted in Formula (30) to obtain Formula (31) since x>a is true.

$$w = \frac{P}{\text{?}} \{ - {bx}^{3} + {{L}_{B} ( x - a )}^{3} + ab ( a + 2 b ) x \} \qquad ( 31 )$$

$$\text{?} \text{indicates text missing or illegible when filed}$$

When setting the position a of the load P to a=L_{B}r, substituting a=L_{B}r and b=L_{B}(1−r) in Formula (31), and then coordinating the result, the deflection amount w_{std} obtained by standardizing the deflection amount w can be obtained by Formula (32). The character r represents the ratio of the position a of the load P to the length L_{B} of the upper structure 7.

$$\text{?} = \frac{8}{{L}_{B}} \{ {xr}^{3} + ( \frac{{x}^{3}}{{L}_{B}^{2}} + 2 x ) r \} - \frac{8}{{L}_{B}} ( {L}_{B} {r}^{3} + \frac{3 {x}^{2}}{{L}_{B}} r ) \qquad ( 32 )$$

$$\text{?} \text{indicates text missing or illegible when filed}$$

Similarly, when the position a of the load P is located at the exit end side of the observation position x, Hₐ=0 is substituted in Formula (30) to obtain Formula (33) since x≤a is true.

$$w = \frac{P}{\text{?}} \{ - {bx}^{3} + ab ( {L}_{B} + b ) x \} \qquad ( 33 )$$

$$\text{?} \text{indicates text missing or illegible when filed}$$

When setting the position a of the load P to a=L_{B}r, substituting a=L_{B}r and b=L_{B}(1−r) in Formula (33), and then coordinating the result, the deflection amount w_{std} obtained by standardizing the deflection amount w can be obtained by Formula (34).

$$\text{?} = \frac{8}{{L}_{B}} \{ {xr}^{3} + ( \frac{{x}^{3}}{{L}_{B}^{2}} + 2 x ) r \} - \frac{8}{{L}_{B}} ( 3 {xr}^{2} + \frac{{x}^{3}}{{L}_{B}^{2}} ) \qquad ( 34 )$$

$$\text{?} \text{indicates text missing or illegible when filed}$$

By putting Formula (32) and Formula (34) together, the deflection amount w_{std}(r) at an arbitrary observation position x=Lₓ is expressed as Formula (35). In Formula (35), a function R(r) is expressed as Formula (36). Formula (35) is an approximation formula of the deflection of the upper structure 7 as a structural object, and is a formula based on a structural model of the upper structure 7. Specifically, Formula (35) is an approximation formula standardized with the maximum amplitude of the deflection at a central position between the approach end and the exit end of the upper structure 7.

$$\text{?} ( r ) = \frac{8}{{L}_{B}} \{ {L}_{x} {r}^{3} + ( \frac{{L}_{x}^{3}}{{L}_{B}^{2}} + 2 {L}_{x} ) r - R ( r ) \} \qquad ( 35 )$$

$$R ( r ) = \{ \begin{matrix}{L}_{B} {r}^{3} + \frac{3 {L}_{x}^{2}}{{L}_{B}} r & ( if {L}_{x} > {L}_{B} r ) \\ 3 {L}_{x} {r}^{2} + \frac{{L}_{x}^{3}}{{L}_{B}^{2}} & ( if {L}_{x} \leq {L}_{B} r )\end{matrix} \qquad ( 36 )$$

$$\text{?} \text{indicates text missing or illegible when filed}$$

In the present embodiment, the load P is a load by an arbitrary axle of the railroad vehicle 6. The time tₓₙ required for the arbitrary axle of the railroad vehicle 6 to reach the position Lₓ of the observation point R from the approach end of the upper structure 7 is calculated with Formula (37) using the average velocity vₐ calculated with Formula (12).

$${t}_{xn} = \frac{{L}_{x}}{{v}_{a}} \qquad ( 37 )$$

Further, the time tₗₙ required for the arbitrary axle of the railroad vehicle 6 to pass through the upper structure 7 having the length L_{B} is calculated with Formula (38).

$$\text{?} = \frac{{L}_{B}}{{v}_{a}} \qquad ( 38 )$$

$$\text{?} \text{indicates text missing or illegible when filed}$$

The time t₀(Cₘ,n) when the n-th axle in the Cₘ-th vehicle of the railroad vehicle 6 reaches the approach end of the upper structure 7 is calculated with Formula (39) using the approach time tᵢ included in the observation information, the distance D_{wa}(a_{w}(Cₘ,n)) calculated with Formula (10), and the average velocity vₐ calculated with Formula (12).

$${t}_{0} ( {C}_{m} , n ) = {t}_{i} + \frac{1}{{v}_{a}} {D}_{wa} ( {a}_{w} ( {C}_{m} , n ) ) \qquad ( 39 )$$

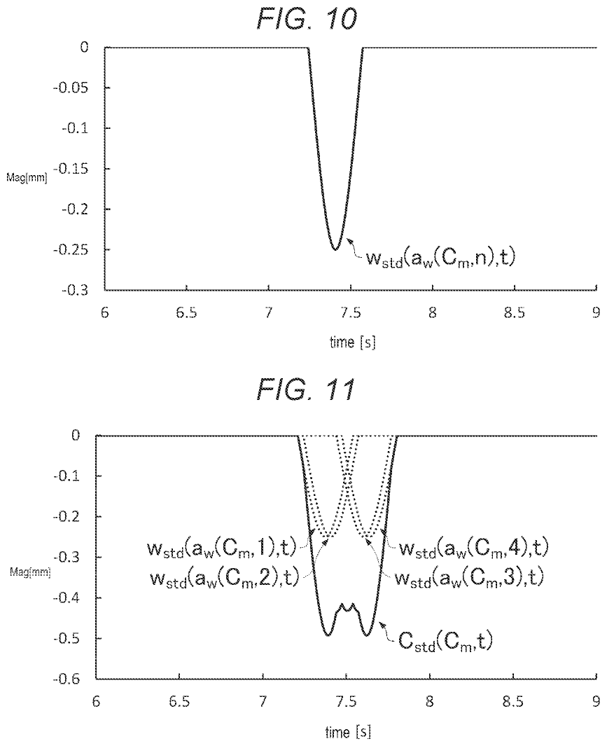

The measurement device 1 calculates the deflection amount w_{std}(a_{w}(Cₘ,n),t), which is obtained by replacing the deflection amount w_{std}(r) expressed by Formula (35) by the n-th axle in the Cₘ-th vehicle with time, with Formula (40) using Formula (37), Formula (38), and Formula (39). In Formula (40), a function R(t) is expressed as Formula (41). FIG. 10 shows an example of the deflection amount w_{std}(a_{w}(Cₘ,n),t).

$$\text{?} ( {a}_{w} ( {C}_{m} , n ) , t ) = \{ \begin{matrix}0 & if ( t < \text{?} ( {C}_{m} , n ) ) \\ \text{?} - R ( t ) \} & if ( {t}_{0} ( {C}_{m} , n ) \leq t \leq \text{?} ( {C}_{m} , n ) \text{?} \\ 0 & if ( {t}_{0} ( {C}_{m} , n ) + \text{?} < t )\end{matrix} \qquad ( 40 )$$

$$R ( r ) = \{ \begin{matrix}0 & if ( t < {t}_{0} ( {C}_{m} , n ) ) \\ \text{?} & if ( {t}_{0} ( {C}_{m} , n ) \leq t \leq {t}_{0} ( {C}_{m} , n ) + \text{?} > t - {t}_{0} ( {C}_{m} , n ) ) \\ \text{?} & if ( {t}_{0} ( {C}_{m} , n ) \leq t \leq {t}_{0} ( {C}_{m} , n ) + \text{?} \leq t - {t}_{0} ( {C}_{m} , n ) ) \\ 0 & if ( {t}_{0} ( {C}_{m} , n ) + \text{?}\end{matrix} \qquad ( 41 )$$

$$\text{?} \text{indicates text missing or illegible when filed}$$

Further, the measurement device 1 calculates a deflection amount C_{std}(Cₘ,t) by the Cₘ-th vehicle with Formula (42). FIG. 11 shows an example of the deflection amount C_{std}(Cₘ,n) by the Cₘ-th vehicle with the number of axles n=4.

$${C}_{std} ( {C}_{m} , t ) = \text{?} {w}_{std} ( {a}_{w} ( {C}_{m} , n ) , t ) \qquad ( 42 )$$

$$\text{?} \text{indicates text missing or illegible when filed}$$

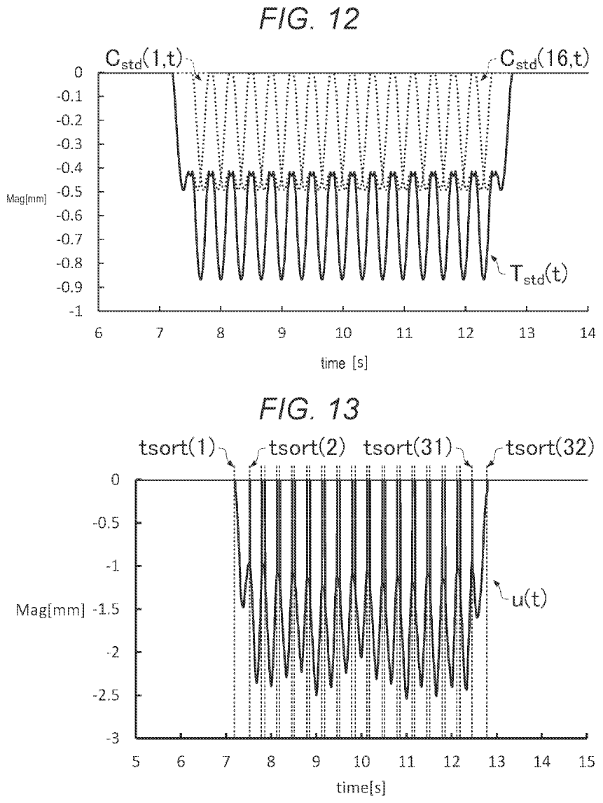

With Formula (43), a deflection amount T_{std}(t) by the railroad vehicle 6 can be obtained. FIG. 12 shows an example of the deflection amount T_{std}(t) by the railroad vehicle 6 with the number of vehicles C_{T}=16. It should be noted that in FIG. 12, the dotted lines represent 16 deflection amounts C_{std}(1,t) through C_{std}(16,t).

$${T}_{std} ( t ) = \text{?} {C}_{std} ( {C}_{m} , t ) \qquad ( 43 )$$

$$\text{?} \text{indicates text missing or illegible when filed}$$

The deflection amount T_{std}(t) by the railroad vehicle 6 is what is obtained by adding the deflection amounts C_{std}(Cₘ,t) of respective vehicles to each other, and the amplitude of the upper structure 7 by each of the vehicles is constant. In reality, since the loads by the respective vehicles are different from each other, the amplitude of the displacement of the upper structure 7 by the application of the load by each of the vehicles is different in proportion to the load. Therefore, in order to express the difference in amplitude of the deflection of the upper structure 7 by the application of the load by each of the vehicles, there is provided weighting by the load by each of the vehicles. The deflection amount C_{p_std}(Cₘ,t) by each of the vehicles weighted by the load is expressed as Formula (44) using a weighting coefficient P_{C}_{ₘ} by the load by the Cₘ-th vehicle.

$${C}_{p \_ std} ( {C}_{m} , t ) = {P}_{{C}_{m}} {\sum }_{n = 1}^{{a}_{T} ( {C}_{m} )} {w}_{std} ( {a}_{w} ( {C}_{m} , n ) , t ) \qquad ( 44 )$$

The deflection amount T_{p_std}(t) by the railroad vehicle 6 weighted in accordance with the loads by the respective vehicles is expressed as Formula (45) using the weighting coefficients P_{C}_{ₘ}.

$${T}_{p \_ std} ( t ) = {\sum }_{{C}_{m} = 1}^{{C}_{T}} {C}_{p \_ std} ( {C}_{m} , t ) = {\sum }_{{C}_{m} = 1}^{{C}_{T}} {P}_{{C}_{m}} {C}_{std} ( {C}_{m} , t ) \qquad ( 45 )$$

According to Formula (43) and Formula (45), when all of the weighting coefficients P_{C}_{ₘ} are 1, Formula (46) is true.

T_{std}(t)=T_{p_std}(t) (46)

The measurement device 1 divides the interval from the approach time tᵢ to the exit time tₒ with respect to the upper structure 7 of the railroad vehicle 6 into a plurality of time intervals, and then compares the displacement data u(t) and a sum of the deflection amount C_{std}(Cₘ,t) of each of the vehicles in each of the time internals to thereby calculate the weighting coefficients P_{C}_{ₘ}.

The approach time tₒ the upper structure 7 of the Cₘ-th vehicle of the railroad vehicle 6 is the time to(Cₘ,1) when the head axle of the Cₘ-th vehicle approaches the upper structure 7. The approach time to(Cₘ,1) to the upper structure 7 of the Cₘ-th vehicle is calculated with Formula (47) obtained by substituting n with 1 in Formula (39) described above. As expressed in Formula (47), the approach time to(Cₘ,1) to the upper structure 7 of the Cₘ-th vehicle is calculated by adding elapsed time D_{wa}(a_{w}(Cₘ,1))/vₐ from when the head axle of the railroad vehicle 6 passes the approach end of the upper structure 7 to when the head axle of the Cₘ-th vehicle passes the approach end to the approach time tᵢ when the head axle of the railroad vehicle 6 passes the approach end of the upper structure 7.

$${t}_{0} ( {C}_{m} , 1 ) = {t}_{i} + \frac{1}{{v}_{a}} {D}_{wa} ( {a}_{w} ( {C}_{m} , 1 ) ) \qquad ( 47 )$$

Further, the exit time from the upper structure 7 of the Cₘ-th vehicle of the railroad vehicle 6 is the time to(Cₘ,a_{T}(Cₘ)) when the rearmost axle of the Cₘ-th vehicle exits from the upper structure 7. As expressed in Formula (48), the exit time to(Cₘ,a_{T}(Cₘ)) from the upper structure 7 of the Cₘ-th vehicle is calculated by adding elapsed time {L_{B}+D_{wa}(a_{w}(Cₘ,a_{T}(Cₘ))}/vₐ from when the head axle of the railroad vehicle 6 passes the approach end of the upper structure 7 to when the rearmost axle of the Cₘ-th vehicle passes the exit end to the approach time tᵢ when the head axle of the railroad vehicle 6 passes the approach end of the upper structure 7.

$${t}_{0} ( {C}_{m} , {a}_{T} ( {C}_{m} ) ) = {t}_{i} + \frac{1}{{v}_{a}} \{ {L}_{B} + {D}_{wa} ( {a}_{w} ( {C}_{m} , {a}_{T} ( {C}_{m} ) ) ) \} \qquad ( 48 )$$

Then, the measurement device 1 sorts the CT pieces of approach times t₀(1,1), t₀(2,1), . . . , and t₀(C_{T},1), and C_{T} pieces of exit times t₀(1,a_{T}(1)), t₀(2,a_{T}(2)), . . . , and t₀(C_{T},a_{T}(C_{T})) by time, namely in ascending order, to calculate 2C_{T} pieces of times tsort(1), tsort(2), . . . , tsort(C_{T}−1), and tsort(2C_{T}) Then, the measurement device 1 calculates the time interval from the time tsort(n) to the time tsort(n+1) as the n-th time interval tₙ with respect to each of integers n no smaller than 1 and no larger than 2C_{T}−1.

Then, the measurement device 1 calculates an amplitude amount u_{M}(n) of the displacement data u(t) in the n-th time interval tₙ with respect to each of integers n no smaller than 1 and no larger than 2C_{T}−1. For example, the amplitude amount u_{M}(n) is an average value or an integrated value. When the amplitude amount u_{M}(n) is the average value uₐ(n), the amplitude amount u_{M}(n) is calculated with Formula (49). FIG. 13 shows an example of a relationship between the displacement data u(t) and the times tsort(1) through tsort (2C_{T}).

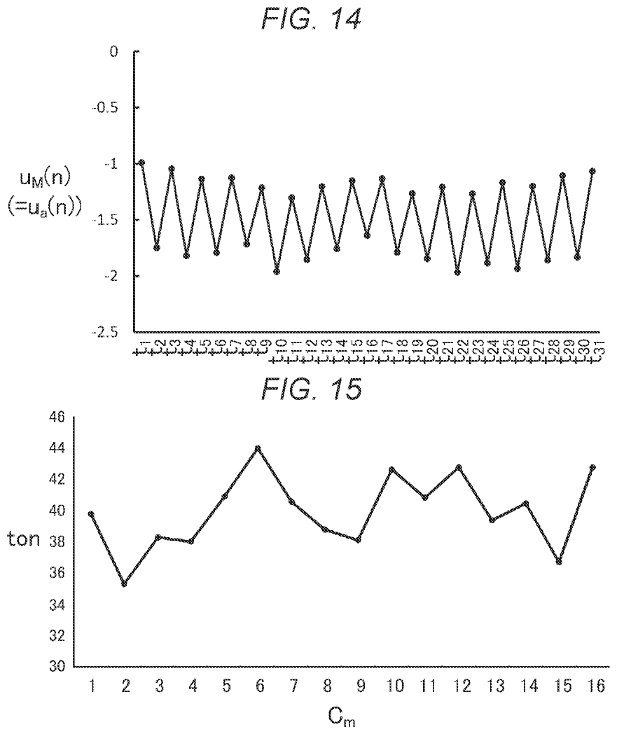

Further, FIG. 14 shows an example of the average value uₐ(n) as the amplitude amounts u_{M}(n) of the displacement data u(t) in the time intervals tₙ. In FIG. 13, FIG. 14, C_{T}=16 is assumed.

$${u}_{M} ( n ) = {u}_{a} ( n ) = \frac{1}{{t}_{sort} ( n + 1 ) - {t}_{sort} ( n )} {\sum }_{k = {t}_{sort} ( n )}^{{t}_{sort} ( n + 1 )} u ( k ) \qquad ( 49 )$$

Further, when the amplitude amount u_{M}(n) is the integrated value uₛ(n), the amplitude amount u_{M}(n) of the displacement data u(t) in the time interval tₙ is calculated with Formula (50).

$${u}_{M} ( n ) = {u}_{s} ( n ) = {\sum }_{k = {t}_{sort} ( n )}^{{t}_{sort} ( n + 1 )} u ( k ) \qquad ( 50 )$$

It should be noted that when the time tsort(n) and the time tsort(n+1) are equal to each other, the amplitude amount uM(n)=0 is set instead of Formula (49) or Formula (50).

Then, the measurement device 1 calculates an amplitude amount C_{std_M}(n, Cₘ) of the deflection amount C_{std}(Cₘ, t) by the Cₘ-th vehicle in the n-th time interval tₙ with respect to each of the integers n no smaller than 1 and no larger than 2C_{T}−1. For example, the amplitude amount C_{std_M}(n, Cₘ) is an average value or an integrated value. When the amplitude amount C_{std_M}(n, Cₘ) is the average value C_{std_a}(n, Cₘ), the amplitude amount C_{std_M}(n, Cₘ) is calculated with Formula (51).

$${C}_{std \_ M} ( n , {C}_{m} ) = {C}_{std \_ a} ( n , {C}_{m} ) = \frac{1}{{t}_{sort} ( n + 1 ) - {t}_{sort} ( n )} {\sum }_{t = {t}_{sort} ( n )}^{{t}_{sort} ( n + 1 )} {C}_{std} ( {C}_{m} , t ) \qquad ( 51 )$$

Further, when the amplitude amount C_{std_M}(n, Cₘ) is the integrated value C_{std_s}(n, Cₘ), the amplitude amount C_{std_M}(n, Cₘ) of the displacement data u(t) in the time interval tₙ is calculated with Formula (52).

$${C}_{std \_ M} ( n , {C}_{m} ) = {C}_{std \_ s} ( n , {C}_{m} ) = {\sum }_{t = {t}_{sort} ( n )}^{{t}_{sort} ( n + 1 )} {C}_{std} ( {C}_{m} , t ) \qquad ( 52 )$$

It should be noted that when the time tsort(n) and the time tsort(n+1) are equal to each other, the amplitude amount C_{std_M}(n,Cₘ)=0 is set instead of Formula (51) or Formula (52).

As expressed in Formula (53), the measurement device 1 calculates the weighting coefficients P_{C}_{ₘ} assuming that a sum of products of the amplitude amount C_{std_M}(n,Cₘ) of the deflection amount C_{std}(Cₘ,t) by each of the vehicles in the time interval tₙ and the weighting coefficient P_{C}_{ₘ} with respect to each of the vehicles is equal to the amplitude amount u_{M}(n) of the displacement data u(t) in the time interval tn.

$$( \begin{matrix}{C}_{std \_ M} ( 1 , 1 ) & {C}_{std \_ M} ( 1 , 2 ) & … & {C}_{std \_ M} ( 1 , {C}_{T} ) \\ {C}_{std \_ M} ( 2 , 1 ) & {C}_{std \_ M} ( 2 , 2 ) & … & {C}_{std \_ M} ( 2 , {C}_{T} ) \\ ⋮ & ⋮ & ⋮ & ⋮ \\ {C}_{std \_ M} ( 2 {C}_{T} - 1 , 1 ) & {C}_{std \_ M} ( 2 {C}_{T} - 1 , 2 ) & … & {C}_{std \_ M} ( 2 {C}_{T} - 1 , {C}_{T} )\end{matrix} ) ( \begin{matrix}{P}_{{c}_{1}} \\ {P}_{{c}_{2}} \\ ⋮ \\ {P}_{{c}_{T}}\end{matrix} ) = ( \begin{matrix}{u}_{M} ( 1 ) \\ {u}_{M} ( 2 ) \\ ⋮ \\ {u}_{M} ( 2 {C}_{T} - 1 )\end{matrix} ) \qquad ( 53 )$$

When the amplitude amount u_{M}(n) and the amplitude amount C_{std_M}(n, Cₘ) are the average value uₛ(n) and the average value C_{std_a}(n,Cₘ) f respectively, the weighting coefficients P_{C}_{ₘ} are calculated from Formula (54).

$$( \begin{matrix}{C}_{std \_ a} ( 1 , 1 ) & {C}_{std \_ a} ( 1 , 2 ) & … & {C}_{std \_ a} ( 1 , {C}_{T} ) \\ {C}_{std \_ a} ( 2 , 1 ) & {C}_{std \_ a} ( 2 , 2 ) & … & {C}_{std \_ a} ( 2 , {C}_{T} ) \\ ⋮ & ⋮ & ⋮ & ⋮ \\ {C}_{std \_ a} ( 2 {C}_{T} - 1 , 1 ) & {C}_{std \_ a} ( 2 {C}_{T} - 1 , 2 ) & … & {C}_{std \_ a} ( 2 {C}_{T} - 1 , {C}_{T} )\end{matrix} ) ( \begin{matrix}{P}_{{c}_{1}} \\ {P}_{{c}_{2}} \\ ⋮ \\ {P}_{{c}_{T}}\end{matrix} ) = ( \begin{matrix}{u}_{a} ( 1 ) \\ {u}_{a} ( 2 ) \\ ⋮ \\ {u}_{a} ( 2 {C}_{T} - 1 )\end{matrix} ) \qquad ( 54 )$$

Further, when the amplitude amount u_{M}(n) and the amplitude amount C_{std_M}(n,Cₘ) are the integrated value uₛ(n) and the integrated value C_{std_s}(n,Cₘ), respectively, the weighting coefficients P_{C}_{ₘ} are calculated from Formula (55).

$$( \begin{matrix}{C}_{std \_ s} ( 1 , 1 ) & {C}_{std \_ s} ( 1 , 2 ) & … & {C}_{std \_ s} ( 1 , {C}_{T} ) \\ {C}_{std \_ s} ( 2 , 1 ) & {C}_{std \_ s} ( 2 , 2 ) & … & {C}_{std \_ s} ( 2 , {C}_{T} ) \\ ⋮ & ⋮ & ⋮ & ⋮ \\ {C}_{std \_ s} ( 2 {C}_{T} - 1 , 1 ) & {C}_{std \_ s} ( 2 {C}_{T} - 1 , 2 ) & … & {C}_{std \_ s} ( 2 {C}_{T} - 1 , {C}_{T} )\end{matrix} ) ( \begin{matrix}{P}_{{c}_{1}} \\ {P}_{{c}_{2}} \\ ⋮ \\ {P}_{{c}_{T}}\end{matrix} ) = ( \begin{matrix}{u}_{s} ( 1 ) \\ {u}_{s} ( 2 ) \\ ⋮ \\ {u}_{s} ( 2 {C}_{T} - 1 )\end{matrix} ) \qquad ( 55 )$$

It is possible to determine a difference in weight between the vehicles from the weighting coefficients P₁ through P_{CT}. For example, when assuming an average weight of the 1-st through C_{T}-th vehicles as 40 tons, the weight of the Cₘ-th vehicle is calculated by making the average value P_{avg} of the weighting coefficients P₁ through P_{CT} correspond to 40 tons, and then multiplying the 40 tons by a ratio between the weighting coefficient P_{C}_{ₘ} and the average value P_{avg}. FIG. 15 shows an example of the weights of 1-st through C_{T}-th vehicles calculated from the weighting coefficients P₁ through P_{CT}. In FIG. 15, C_{T}=16 is assumed.

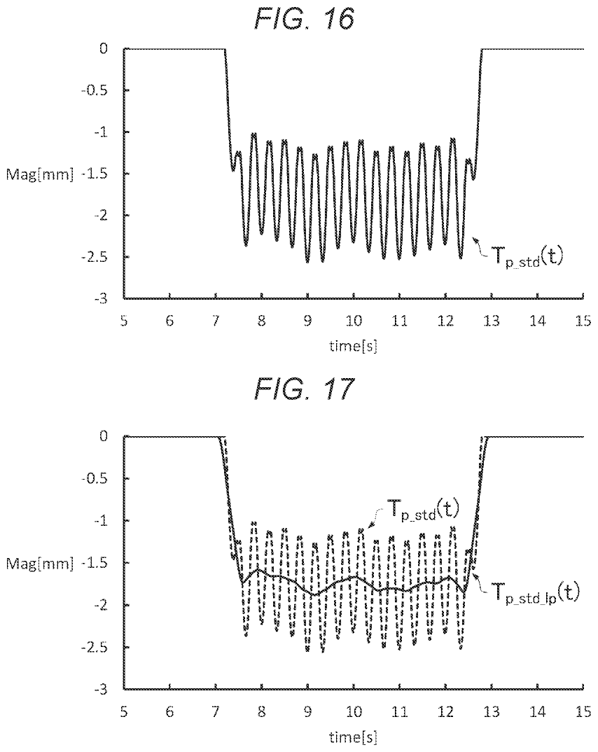

The measurement device 1 substitutes the weighting coefficients P₁ through P_{CT} calculated with Formula (53), specifically Formula (54) or Formula (55), in Formula (45) described above to thereby calculate the deflection amount T_{p_std}(t) by the railroad vehicle 6 weighted in accordance with the loads by the respective vehicles. FIG. 16 shows an example of the deflection amount T_{p_std}(t).

Then, the measurement device 1 calculates a static response when the railroad vehicle 6 moves on the upper structure 7 using the deflection amount T_{p_std}(t) Specifically, first, in order to reduce a vibration component of a basic frequency F_{M} and a harmonic wave thereof included in the deflection amount T_{p_std}(t), the measurement device 1 generates the deflection amount T_{p_std_lp}(t) obtained by performing filter processing on the deflection amount T_{p_std}(t). The filter processing can be, for example, a lowpass filter processing, and can also be a bandpass filter processing.

Specifically, first, the measurement device 1 performs fast Fourier transformation processing on the deflection amount T_{p_std}(t) to calculate the power spectral density, and calculates a peak of the power spectral density as the basic frequency F_{M}. Then, the measurement device 1 calculates the basic period T_{M} from the basic frequency F_{M} with Formula (56), and then calculates a moving average interval k_{mM} obtained by dividing the basic period T_{M} by ΔT to adjust the basic period T_{M} to have the temporal resolution of the data as expressed in Formula (57). The basic period T_{M} is a period corresponding to the basic frequency F_{M}, and fulfills T_{M}>2ΔT.

$${T}_{M} = \frac{1}{{f}_{M}} \qquad ( 56 )$$

$${k}_{mM} = 2 ⌊ \frac{{T}_{M}}{2 Δ T} ⌋ + 1 \qquad ( 57 )$$

Then, as the filter processing, the measurement device 1 performs moving average processing on the deflection amount T_{p_std}(t) with the basic period T_{M} using Formula (58) to generate the deflection amount T_{p_std_lp}(t) obtained by reducing the vibration component included in the deflection amount T_{p_std}(t). Since the moving average processing is not only small in necessary calculation amount, but also extremely large in attenuation amounts of the signal component of the basic frequency F_{M} and the harmonic component thereof, it is possible to obtain the deflection amount T_{p_std_lp}(t) in which the vibration component is effectively reduced. FIG. 17 shows an example of the deflection amount T_{p_std_lp}(t). As shown in FIG. 17, it is possible to obtain the deflection amount T_{p_std_lp}(t) in which most of the vibration component included in the deflection amount T_{p_std}(t) is removed.

$${T}_{p \_ std \_ lp} ( k ) = \frac{1}{{k}_{mM}} {\sum }_{n = k - \frac{{k}_{mM} - 1}{2}}^{k + \frac{{k}_{mM} - 1}{2}} {T}_{p \_ std} ( n ) \qquad ( 58 )$$

It should be noted that it is possible for the measurement device 1 to perform the FIR filter processing of attenuating a signal component with a frequency no lower than the basic frequency F_{M} on the deflection amount T_{p_std}(t) as the filter processing to thereby generate the deflection amount T_{p_std_lp}(t). The FIR filter processing is larger in calculation amount than the moving average processing, but is capable of attenuating all of the signal components having frequencies no lower than the basic frequency F_{M}.

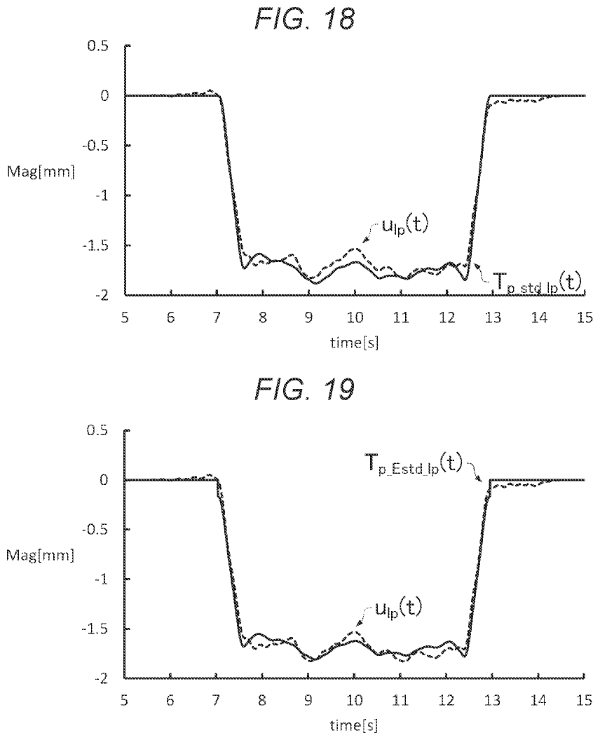

FIG. 18 shows the displacement data uₗₚ(t) shown in FIG. 5 and the deflection amount T_{p_std_lp}(t) shown in FIG. 17 in an overlapping manner. The deflection amount T_{p_std_lp}(t) is considered as a deflection amount proportional to the load by the railroad vehicle 6 passing through the upper structure 7, and it is assumed that a linear function of the deflection amount T_{p_std_lp}(t) becomes substantially equal to the displacement data uₗₚ(t). In other words, as expressed in Formula (59), the measurement device 1 approximates the displacement data uₗₚ(t) with the linear function of the deflection amount T_{p_std_lp}(t). It should be noted that the time interval to be approximated is assumed as an interval between the approach time tᵢ and the exit time tₒ, or a time interval in which the amplitude of the deflection amount T_{p_stp_lp}(t) is not zero.

uₗₚ(t)≅c₁T_{p_std_lp}(t)+c₀ (59)

Then, the measurement device 1 calculates a coefficient cᵢ of the linear term and a constant term c₀ of the linear function expressed by Formula (59). For example, the measurement device 1 calculates the coefficient c₁ of the linear term and the constant term c₀ with which an error e(t) expressed by Formula (60), namely a difference between the displacement data uₗₚ(t) and the linear function expressed by Formula (59), becomes the smallest using the least-square method.

$$e ( t ) = {u}_{lp} ( t ) - {c}_{1} {T}_{p \_ std \_ lp} ( t ) + {c}_{0} \\ {t}_{i} \leq t \leq {t}_{o} \qquad ( 60 )$$

The coefficient c₁ of the linear term and the constant term c₀ are respectively calculated with Formula (61) and Formula (62). A data interval corresponding to the time interval tₙ be approximated is defined as kₐ≤k≤k_{b}.

$${c}_{1} = \{ n {\sum }_{k = {k}_{a}}^{{k}_{b}} {u}_{lp} ( k ) {T}_{p \_ std \_ lp} ( k ) - {\sum }_{k = {k}_{a}}^{{k}_{b}} {T}_{p \_ std \_ lp} ( k ) {\sum }_{k = {k}_{a}}^{{k}_{b}} {u}_{lp} ( k ) \} / \qquad ( 61 )$$

$$\{ n {\sum }_{k = {k}_{a}}^{{k}_{b}} {{T}_{p \_ std \_ lp} ( k )}^{2} - {\sum }_{k = {k}_{a}}^{{k}_{b}} {{T}_{p \_ std \_ lp} ( k )}^{2} \}$$

$$n = {\sum }_{k = {k}_{a}}^{{k}_{b}} 1 \\ {c}_{0} = \{ {\sum }_{k = {k}_{a}}^{{k}_{b}} {u}_{lp} ( k ) - {c}_{1} {\sum }_{k = {k}_{a}}^{{k}_{b}} {T}_{p \_ std \_ lp} ( k ) \} / n \\ n = {\sum }_{k = {k}_{a}}^{{k}_{b}} 1 \qquad ( 62 )$$

Further, as expressed in Formula (63), the measurement device 1 calculates a deflection amount T_{p_std_lp} obtained by adjusting the deflection amount T_{p_std_lp}(t) using the coefficient cᵢ of the linear term and the constant term c₀. As expressed by Formula (63), the deflection amount T_{p_std_lp}(t) basically corresponds to the right-hand side of Formula (59), but in the intervals before the approach time tᵢ and the intervals after the exit time tₒ, the constant term c₀ is set to zero. FIG. 19 shows an example of the deflection amount T_{p_std_lp}(t).

$${T}_{p \_ Estd \_ lp} ( t ) = \{ \begin{matrix}t < {t}_{i} & {c}_{1} {T}_{p \_ std \_ lp} ( t ) \\ {t}_{i} \leq t \leq {t}_{o} & {c}_{1} {T}_{p \_ std \_ lp} ( t ) + {c}_{0} \\ {t}_{o} < t & {c}_{1} {T}_{p \_ std \_ lp} ( t )\end{matrix} \qquad ( 63 )$$

Further, as expressed in Formula (64), it is assumed that the linear function of the deflection amount T_{p_std}(t) using the coefficient cᵢ of the linear term calculated with Formula (61) and the constant term c₀ calculated with Formula (62) becomes substantially equal to the displacement data u(t).

$$u ( t ) ≅ {c}_{1} {T}_{p \_ std} ( t ) + {c}_{0} \\ {t}_{i} \leq t \leq {t}_{o} \qquad ( 64 )$$

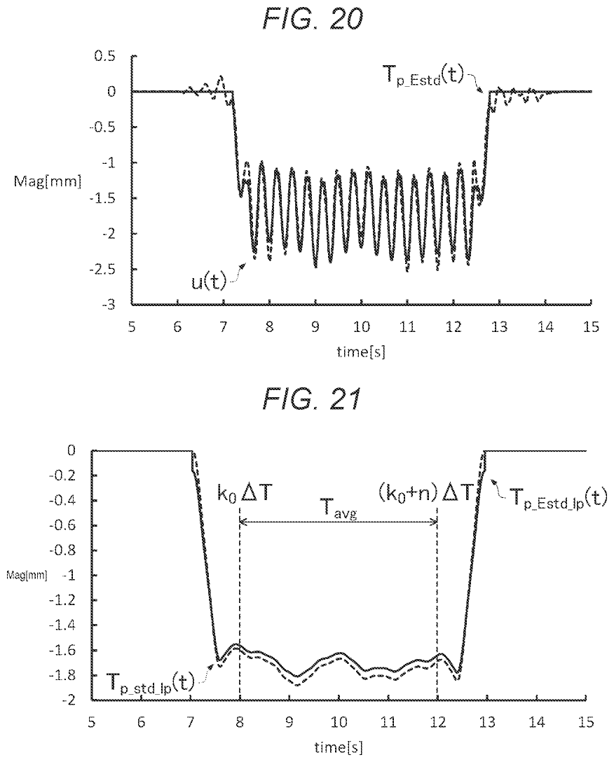

The deflection amount T_{p_Estd}(t) obtained by adjusting the deflection amount T_{p_std}(t) using the coefficient cᵢ of the linear term and the constant term c₀ is calculated using Formula (65). The right-hand side of Formula (65) is obtained by replacing T_{p_std_lp}(t) in the right-hand side of Formula (63) with T_{p_std}(t). FIG. 20 shows an example of the deflection amount T_{p_Estd}(t).

$${T}_{p \_ Estd} ( t ) = \{ \begin{matrix}t < {t}_{i} & {c}_{1} {T}_{p \_ std} ( t ) \\ {t}_{i} \leq t \leq {t}_{o} & {c}_{1} {T}_{p \_ std} ( t ) + {c}_{0} \\ {t}_{o} < t & {c}_{1} {T}_{p \_ std} ( t )\end{matrix} \qquad ( 65 )$$

Then, the measurement device 1 calculates an amplitude ratio RT between the deflection amount T_{p_Estd_lp}(t) and the deflection amount T_{p_std_lp}(t) in a predetermined interval using Formula (66) assuming t=kΔT. In Formula (66), the numerator is an average value of n+1 samples of the deflection amount T_{p_std_lp} (t) included in the predetermined interval as a part of an interval in which the waveform of the deflection amount T_{p_Estd_lp}(t) and the waveform of the deflection amount T_{p_std_lp}(t) are shifted, and the denominator is an average value of n+1 samples of the deflection amount T_{p_std_lp}(t) included in that interval. FIG. 21 shows an example of a relationship between the deflection amount T_{p_std_lp}(t) and the deflection amount T_{p_std_lp}(t), and the predetermined interval T_{avg} for calculating the respective average values of the deflection amounts.

$${R}_{T} = ( \frac{1}{n + 1} {\sum }_{k = {k}_{0}}^{{k}_{0} + n} {T}_{p \_ Estd \_ lp} ( k ) ) / ( \frac{1}{n + 1} {\sum }_{k = {k}_{0}}^{{k}_{0} + n} {T}_{p \_ std \_ lp} ( k ) ) \qquad ( 66 )$$

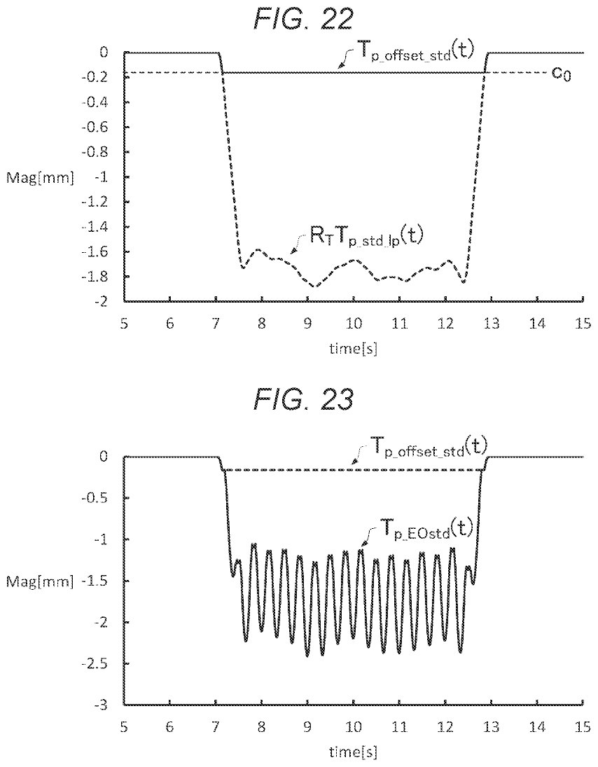

Then, the measurement device 1 compares a product R_{T}T_{p_std_lp}(t) of the amplitude ratio RT and the deflection amount T_{p_std_lp}(t) with the constant term c₀ to calculate an offset T_{p_offset_std} (t). Specifically, as expressed in Formula (67), the measurement device 1 replaces the interval of the product R_{T}T_{p_std_lp}(t) of the amplitude ratio RT and the deflection amount T_{p_std_lp}(t) in which an absolute value of the product R_{T}T_{p_std_lp}(t) is higher than the absolute value of the constant term c₀ with the constant term c₀, and thus, calculates the offset T_{p_offset_std} (t). FIG. 22 shows an example of the offset T_{p_offset_std} (t). In the example shown in FIG. 22, since the amplitude of the deflection amount T_{p_std_lp}(t) is 0 or a negative value, the measurement device 1 replaces the interval lower than the constant term c₀ of the product R_{T}T_{p_std_lp}(t) with the constant term c₀ to calculate the offset T_{p_offset_std} (t).

$${T}_{p \_ offset \_ std} ( t ) = \{ \begin{matrix}{R}_{T} {T}_{p \_ std \_ lp} ( t ) \geq {c}_{0} & {R}_{T} {T}_{p \_ std \_ lp} ( t ) \\ {R}_{T} {T}_{p \_ std \_ lp} ( t ) < {c}_{0} & {c}_{0}\end{matrix} \qquad ( 67 )$$

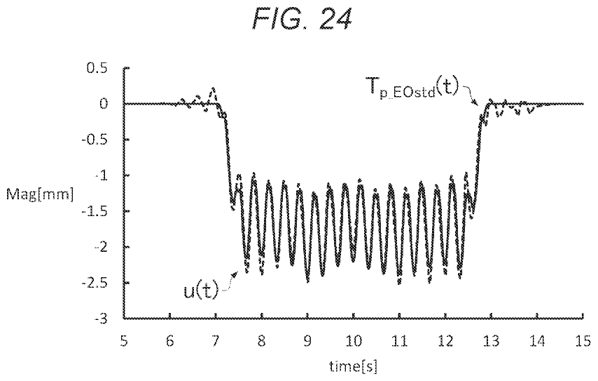

Then, as expressed in Formula (68), the measurement device 1 adds a product c₁T_{p_std}(t) of the coefficient cᵢ of the linear term and the deflection amount T_{p_std}(t) to the offset T_{p_offset_std}(t) to calculate a deflection amount T_{p_EOstd}(t) as the static response. This deflection amount T_{p_Eostd}(t) corresponds to a static response when the railroad vehicle 6 passes through the upper structure 7. FIG. 23 shows an example of the deflection amount T_{p_EOstd}(t). Further, FIG. 24 shows a relationship between the displacement data u(t) and the deflection amount T_{p_EOstd}(t).

T_{p_EOstd}(t)=c₁T_{p_std}(t)+T_{p_offset_std}(t) (68)

### 1-3. Procedure of Measurement Method

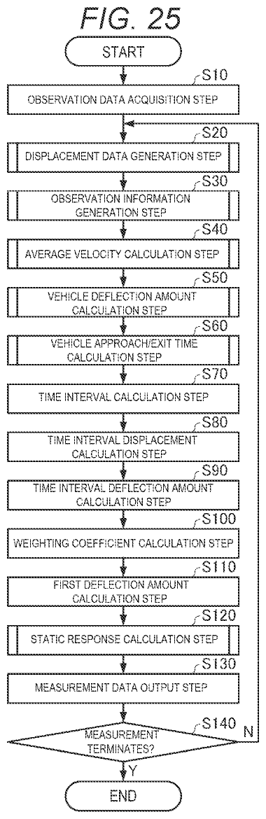

FIG. 25 is a flowchart showing an example of a procedure of a measurement method according to a first embodiment. In the present embodiment, the measurement device 1 executes the procedure shown in FIG. 25.

As shown in FIG. 25, first, in an observation data acquisition step S10, the measurement device 1 obtains the acceleration data a(k) as the observation data output from the sensor 2 as the observation device.

Then, in a displacement data generation step S20, the measurement device 1 generates the displacement data u(t), which are first displacement data based on the acceleration as a physical quantity which is a response to an action on the observation points R of the plurality of axles of the railroad vehicle 6 moving on the upper structure 7, based on the acceleration data a(k) as the observation data obtained in the step S10. An example of the procedure of the displacement data generation step S20 will be described later.

Then, in an observation information generation step S30, the measurement device 1 generates the observation information including the approach time tᵢ and the exit time tₒ with respect to the upper structure 7 of the railroad vehicle 6. The approach time tᵢ is the time when the head axle of the plurality of axles of the railroad vehicle 6 passes the approach end of the upper structure 7, and the exit time tₒ is the time when the rearmost axle of the plurality of axles of the railroad vehicle 6 passes the exit end of the upper structure 7. In the present embodiment, the measurement device 1 generates the observation information including the number of vehicles C_{T} in addition to the approach time tᵢ and the exit time tₒ based on the displacement data u(t) generated in the step S20. An example of the procedure of the observation information generation step S30 will be described later.

Then, in an average velocity calculation step S40, the measurement device 1 calculates the average velocity vₐ of the railroad vehicle 6 based on the observation information generated in the step S30 and the environmental information including the dimensions of the railroad vehicle 6 and the dimensions of the upper structure 7 prepared in advance. The environmental information includes the length L_{B} of the upper structure 7, the position Lₓ of the observation point R, the length L_{c} (Cₘ) of each of the vehicles of the railroad vehicle 6, the number of axles a_{T}(Cₘ) of each of the vehicles, and distance La(a_{w}(Cₘ,n)) between the axles corresponding to the position of each of the plurality of axles of the railroad vehicle 6. An example of the procedure of the average velocity calculation step S40 will be described later.

Then, in a vehicle deflection amount calculation step S50, the measurement device 1 calculates the deflection amount C_{std}(Cₘ,t) of the upper structure 7 by each of the vehicles of the railroad vehicle 6 based on the approximation formula of the upper structure 7 as Formula (35) described above, the observation information generated in the step S30, and the environmental information. In the present embodiment, the measurement device 1 calculates the deflection amount C_{std}(Cₘ,t) based further on the average velocity vₐ of the railroad vehicle 6 calculated in the step S40. An example of the procedure of the vehicle deflection amount calculation step S50 will be described later.

Then, in a vehicle approach/exit time calculation step S60, the measurement device 1 calculates the approach times to(1,1) through to(C_{T},1) and the exit times to(1,a_{T}(1)) through to(C_{T},a_{T}(C_{T})) of the respective vehicles of the railroad vehicle 6 with respect to the upper structure 7 based on the observation information generated in the step S30 and the environmental information. An example of the procedure of the vehicle approach/exit time calculation step S60 will be described later.

Then, in a time interval calculation step S70, the measurement device 1 calculates the time intervals t₁ through t_{2CT-1} divided by the plurality of times tsort(1) through tsort(2C_{T}) obtained by sorting the approach times t₀(1,1) through to(C_{T},1) and the exit times t₀(1,a_{T}(1)) through t₀(C_{T},a_{T}(C_{T})) calculated in the step S60 by time.

Then, in a time interval displacement calculation step S80, the measurement device 1 calculates the amplitude amount u_{M}(n) of the displacement data u(t) in each of the time intervals t₁ through t_{2CT-1} calculated in the step S70. The amplitude amount u_{M}(n) is the average value uₐ(n) or the integrated value uₛ(n). The measurement device 1 calculates the amplitude amount u_{M}(n) using Formula (49) described above when the amplitude amount u_{M}(n) is the average value uₐ(n), or calculates the amplitude amount u_{M}(n) using Formula (50) described above when the amplitude amount u_{M}(n) is the integrated value uₛ(n).

Then, in a time interval deflection amount calculation step S90, the measurement device 1 calculates the amplitude amount C_{std_M}(n,Cₘ) of the deflection amount C_{std}(Cₘ,t) of the upper structure 7 by each of the vehicles in each of the time intervals t₁ through t_{2CT-1} calculated in the step S70. The amplitude amount C_{std_M}(n,Cₘ) is the average value C_{std_a}(n,Cₘ) or the integrated value C_{std_s}(n,Cₘ). The measurement device 1 calculates the amplitude amount C_{std_M}(n,Cₘ) using Formula (51) described above when the amplitude amount C_{std_M}(n,Cₘ) is the average value C_{std_s}(n,Cₘ), or calculates the amplitude amount C_{std_M}(n,Cₘ) using Formula (52) described above when the amplitude amount C_{std_M}(n,Cₘ) is the integrated value C_{std_s}(n,Cₘ).

Then, in a weighting coefficient calculation step S100, the measurement device 1 calculates the weighting coefficients P_{C}_{ₘ} to the respective vehicles assuming that the sum of products of the amplitude amounts C_{std_M}(n,Cₘ) of the deflection amounts C_{std}(Cₘ,t) by the respective vehicles in each of the time intervals t₁ through t_{2CT-1} and the weighting coefficients P_{C}_{ₘ} with respect to the respective vehicles is equal to the amplitude amount u_{M}(n) of the displacement data u(t) in each of the time intervals t₁ through t_{2CT-1}. Specifically, when the amplitude amount u_{M}(n) calculated in the step S80 and the amplitude amount C_{std_M}(n,Cₘ) calculated in the step S90 are the average value uₐ(n) and the average value C_{std_a}(n,Cₘ), respectively, the measurement device 1 calculates the weighting coefficients P_{C}_{ₘ} using Formula (54) described above. Further, when the amplitude amount u_{M}(n) calculated in the step S80 and the amplitude amount C_{std_M}(n,Cₘ) calculated in the step S90 are the integrated value uₛ(n) and the integrated value C_{std_s}(n,Cₘ), respectively, the measurement device 1 calculates the weighting coefficients P_{C}_{ₘ} using Formula (55) described above.

Then, in a first deflection amount calculation step S110, the measurement device 1 calculates the deflection amount T_{p_std}(t) as a first deflection amount of the upper structure 7 by the railroad vehicle 6 using the sum of the products of the weighting coefficients P_{C}_{ₘ} with respect to the respective vehicles of the railroad vehicle 6 calculated in the step S100, and the deflection amounts C_{std}(Cₘ,t) of the upper structure 7 by the respective vehicles calculated in the step S50 as expressed in Formula (45) described above.

Then, in a static response calculation step S120, the measurement device 1 calculates the deflection amount T_{p_Eostd}(t) as the static response when the railroad vehicle 6 moves on the upper structure 7 based on the displacement data u(t) generated in the step S20 and the deflection amount T_{p_std}(t) calculated in the step S110. An example of the procedure of the static response calculation step S120 will be described later.

Then, in a measurement data output step S130, the measurement device 1 outputs measurement data including the weighting coefficients P_{C}_{ₘ} with respect to the respective vehicles calculated in the step S100 and the deflection amount T_{p_EOstd}(t) as the static response calculated in the step S120 to the monitoring device 3. Specifically, the measurement device 1 transmits the measurement data to the monitoring device 3 via the communication network 4. The measurement data can include the displacement data u(t), the deflection amount T_{p_std}(t), and so on in addition to the weighting coefficients P_{C}_{ₘ} and the deflection amount T_{p_EOstd}(t).

Then, the measurement device 1 repeatedly performs the processing in the steps S10 through S130 until the measurement is completed in the step S140.

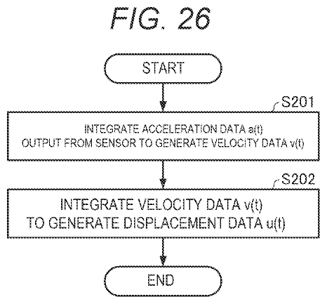

FIG. 26 is a flowchart showing an example of a procedure of the displacement data generation step S20 shown in FIG. 25.

As shown in FIG. 26, in the step S201, the measurement device 1 integrates the acceleration data a(t) output from the sensor 2 to generate the velocity data v(t) as expressed in Formula (1) described above.

Then, in the step S202, the measurement device 1 integrates the velocity data v(t) generated in the step S201 to generate the displacement data u(t) as expressed in Formula (2) described above.

As described above, in the present embodiment, the displacement data u(t) are the data of the displacement of the upper structure 7 by the railroad vehicle 6 as the moving object moving on the upper structure 7 as a structural object, and are data obtained by integrating twice the acceleration in a direction crossing the surface of the upper structure 7 on which the railroad vehicle 6 moves. Therefore, the displacement data u(t) include data of a waveform convex toward the positive direction or the negative direction, specifically, a rectangular waveform, a trapezoidal waveform, or a waveform of a sine half-wave. It should be noted that the rectangular waveform includes not only an accurate rectangular waveform, but also a waveform approximate to the rectangular waveform. Similarly, the trapezoidal waveform includes not only an accurate trapezoidal waveform, but also a waveform approximate to the trapezoidal waveform. Similarly, the waveform of the sine half-wave includes not only a waveform of an accurate sine half-wave, but also a waveform approximate to the sine half-wave.

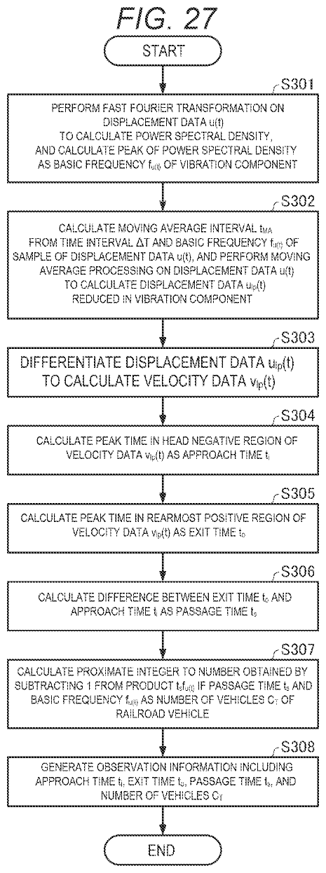

FIG. 27 is a flowchart showing an example of a procedure of the observation information generation step S30 shown in FIG. 25.

As shown in FIG. 27, first, in the step S301, the measurement device 1 performs the fast Fourier transformation processing on the displacement data u(t) generated in the step S20 shown in FIG. 25 to calculate the power spectral density, and calculates the peak of the power spectral density as the basic frequency fᵤ₍ₜ₎ of the vibration component.

Then, in the step S302, the measurement device 1 calculates the moving average interval t_{MA} using Formula (3) described above from the time interval ΔT of the samples of the displacement data u(t) and the basic frequency fᵤ₍ₜ₎ calculated in the step S301, and then performs the moving average processing on the displacement data u(t) to calculate the displacement data uₗₚ(t) in which the vibration component is reduced using Formula (4) described above.

Then, in the step S303, the measurement device 1 differentiates the displacement data uₗₚ(t) calculated in the step S302 to calculate the velocity data vₗₚ(t) using Formula (5) described above.

Then, in the step S304, the measurement device 1 calculates a peak time in a head negative region of the velocity data vₗₚ(t) calculated in the step S303 as the approach time tᵢ.

Then, in the step S305, the measurement device 1 calculates a peak time in a rearmost positive region of the velocity data vₗₚ(t) as the exit time to.

Then, in the step S306, the measurement device 1 calculates a difference between the exit time tₒ calculated in the step S305 and the approach time tᵢ calculated in the step S304 as the passage time tₛ.

Then, in the step S307, the measurement device 1 calculates an integer most approximate to a number obtained by subtracting 1 from a product tₛfᵤ₍ₜ₎ of the passage time is and the basic frequency fᵤ₍ₜ₎ as the number of vehicles CT of the railroad vehicle 6 using Formula (7) and Formula (8) described above.

Then, in the step S308, the measurement device 1 generates the observation information including the approach time tᵢ calculated in the step S304, the exit time to calculated in the step S305, the passage time is calculated in the step S306, and the number of vehicles CT calculated in the step S307.

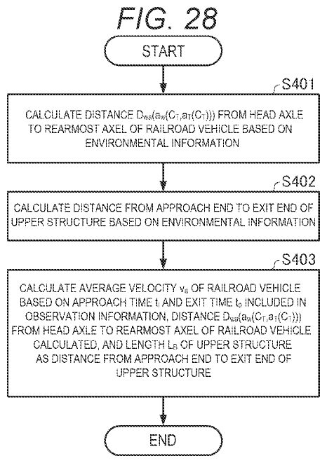

FIG. 28 is a flowchart showing an example of a procedure of the average velocity calculation step S40 shown in FIG. 25.

As shown in FIG. 28, first, in the step S401, the measurement device 1 calculates the distance D_{wa}(a_{w}(C_{T},a_{T}(C_{T}))) from the head axle to the rearmost axle of the railroad vehicle 6 using Formula (11) described above based on the environmental information.

Further, in the step S402, the measurement device 1 calculates the distance from the approach end to the exit end of the upper structure 7 based on the environmental information. In the present embodiment, the distance from the approach end to the exit end of the upper structure 7 is the length L_{B} of the upper structure 7 included in the environmental information.

Then, in the step S403, the measurement device 1 calculates the average velocity vₐ of the railroad vehicle 6 using Formula (12) described above based on the approach time tᵢ and the exit time tₒ included in the observation information generated in the step S308 shown in FIG. 27, the distance D_{wa}(a_{w}(C_{T},a_{T}(C_{T}))) from the head axle to the rearmost axle of the railroad vehicle 6 calculated in the step S401, and the length L_{B} of the upper structure 7 as the distance from the approach end to the exit end of the upper structure 7 calculated in the step S402.

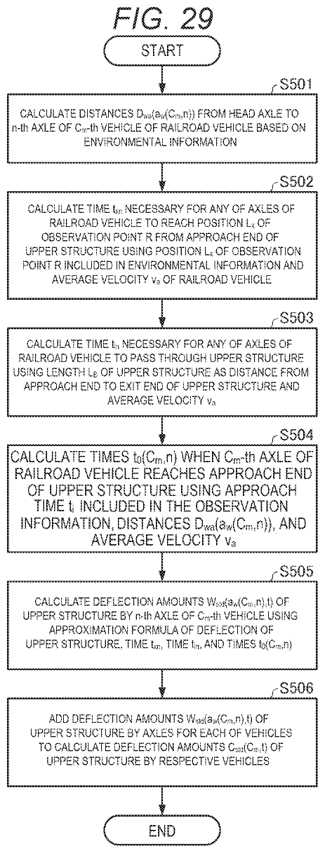

FIG. 29 is a flowchart showing an example of a procedure of the vehicle deflection amount calculation step S50 shown in FIG. 25.

As shown in FIG. 29, first, in the step S501, the measurement device 1 calculates the distance D_{wa}(a_{w}(Cₘ,n)) from the head axle of the railroad vehicle 6 to the n-th axle of the Cₘ-th vehicle using Formula (10) described above based on the environmental information.

Then, in the step S502, the measurement device 1 calculates the time tₓₙ necessary for any of the axles of the railroad vehicle 6 to reach the position Lₓ of the observation point R from the approach end of the upper structure 7 with Formula (37) described above using the position Lₓ of the observation point R and the average velocity vₐ included in the environmental information.

Further, in the step S503, the measurement device 1 calculates the time tin necessary for any of the axles of the railroad vehicle 6 to pass through the upper structure 7 with Formula (38) described above using the length L_{B} of the upper structure 7 as a distance from the approach end to the exit end of the upper structure 7, and the average velocity vₐ.

Further, in the step S504, the measurement device 1 calculates the time to(Cₘ,n) when the n-th axle of the Cₘ-th vehicle of the railroad vehicle 6 with Formula (39) described above using the approach time tᵢ included in the observation information, the distances D_{wa}(a_{w}(Cₘ,n)) calculated in the step S501, and the average velocity vₐ.

Then, in the step S505, the measurement device 1 calculates the deflection amount w_{std}(a_{w}(Cₘ,n),t) of the upper structure 7 by the n-th axle of the Cₘ-th vehicle with Formula (40) described above using an approximation formula of the deflection of the upper structure 7 as Formula (35) described above, the time tₓₙ calculated in the step S502, the time tin calculated in the step S503, and the time t₀(Cₘ,n) calculated in the step S504.

Further, in the step S506, the measurement device 1 adds the deflection amounts w_{std}(a_{w}(Cₘ,n),t) of the upper structure 7 by the respective axles calculated in the step S505 for each of the vehicles with Formula (42) described above to calculate the deflection amount C_{std}(Cₘ,t) of the upper structure 7 by each of the vehicles.

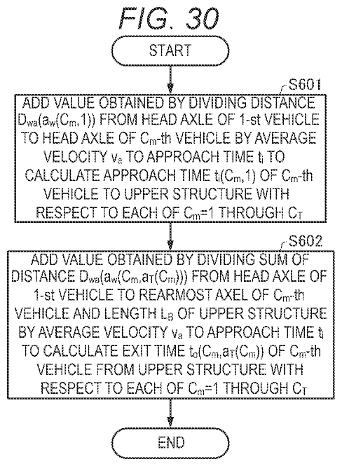

FIG. 30 is a flowchart showing an example of a procedure of the vehicle approach/exit time calculation step S60 shown in FIG. 25.

As shown in FIG. 30, first, in the step S601, the measurement device 1 adds a value obtained by dividing the distance D_{wa}(a_{w}(Cₘ,1)) from the head axle of the 1-st vehicle to the head axle of the Cₘ-th vehicle by the average velocity vₐ to the approach time tᵢ to thereby calculate the approach time to(Cₘ,1) of the Cₘ-th vehicle to the upper structure 7 as expressed in Formula (47) described above with respect to each of Cₘ=1 through C_{T}.

Further, in the step S602, the measurement device 1 adds a value obtained by dividing a sum of the distance D_{wa}(a_{w}(Cₘ,a_{T}(Cₘ))) from the head axle of the 1-st vehicle to the rearmost axle of the Cₘ-th vehicle and the length L_{B} of the upper structure 7 by the average velocity vₐ to the approach time tᵢ to thereby calculate the distance D_{wa}(a_{w}(Cₘ,a_{T}(Cₘ))) of the Cₘ-th vehicle from the upper structure 7 as expressed in Formula (48) described above with respect to each of Cₘ=1 through CT.

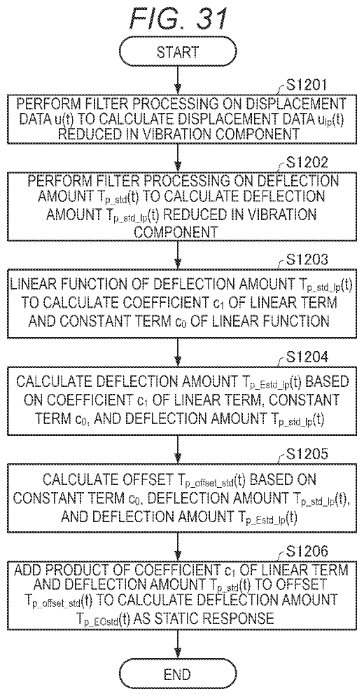

FIG. 31 is a flowchart showing an example of a procedure of the static response calculation step S120 shown in FIG. 25.

As shown in FIG. 31, first, in the step S1201, the measurement device 1 calculates the displacement data uₗₚ(t) as second displacement data obtained by performing the filter processing on the displacement data u(t) as first displacement data generated in the step S20 shown in FIG. 25 to reduce the vibration component. Specifically, the measurement device 1 performs the fast Fourier transformation processing on the displacement data u(t) to calculate the power spectral density, and calculates the peak of the power spectral density as the basic frequency fᵤ₍ₜ₎ of the vibration component. Then, the measurement device 1 calculates the moving average interval t_{MA} using Formula (3) described above from the time interval ΔT of the samples of the displacement data u(t) and the basic frequency fᵤ₍ₜ₎ thus calculated, and then performs the moving average processing on the displacement data u(t) to calculate the displacement data uₗₚ(t) in which the vibration component is reduced using Formula (4) described above.

Then, in the step S1202, the measurement device 1 performs the filter processing on the deflection amount T_{p_std}(t) as a first deflection amount calculated in the step S110 shown in FIG. 25 to calculate the deflection amount T_{p_std_lp}(t) as a second deflection amount in which the vibration component is reduced. Specifically, the measurement device 1 performs the fast Fourier transformation processing on the deflection amount T_{p_std}(t) to calculate the power spectral density, and calculates the peak of the power spectral density as the basic frequency F_{M} of the vibration component. Then, the measurement device 1 calculates the moving average interval k_{mM} using Formula (57) described above from the time interval ΔT and the basic frequency F_{M} thus calculated, and then performs the moving average processing on the deflection amount T_{p_std}(t) to calculate the deflection amount T_{p_std_lp}(t) in which the vibration component is reduced using Formula (58) described above.

Then, in the step S1203, the measurement device 1 approximates the displacement data uₗₚ(t) as the second displacement data calculated in the step S1201 with the linear function of the deflection amount T_{p_std_lp}(t) as the second deflection amount calculated in the step S1202 to calculate the coefficient cᵢ of the linear term and the constant term c₀ of the linear function. Specifically, the measurement device 1 approximates the displacement data uₗₚ(t) with the linear function of the deflection amount T_{p_std_lp}(t) as expressed in Formula (59) described above, and calculates the coefficient cᵢ of the linear term and the constant term c₀ with Formula (61) and Formula (62) described above using the least-square method.

Then, in the step S1204, the measurement device 1 calculates the deflection amount T_{p_Estd_lp}(t) as a third deflection amount based on the coefficient cᵢ of the linear term and the constant term c₀ calculated in the step S1203 and the deflection amount T_{p_std_lp}(t) as the second deflection amount calculated in the step S1202.

Specifically, the measurement device 1 calculates a deflection amount T_{Estd_lp}(t) which is a product c₁T_{p_std_lp}(t) of the coefficient cᵢ of the linear term and the deflection amount T_{Estd_lp}(t) in an interval before the approach time tᵢ and an interval after the exit time tₒ, and which is a sum of the product c₁T_{Estd_lp}(t) and the constant term c₀ in a interval between the approach time tᵢ and the exit time to as expressed in Formula (63) described above.

Then, in the step S1205, the measurement device 1 calculates the offset T_{p_offset_std}(t) based on the constant term c₀ calculated in the step S1203, the deflection amount T_{p_std_lp}(t) as the second deflection amount calculated in the step S1202, and the deflection amount T_{p_Estd_lp} (t) as the third deflection amount calculated in the step S1204. Specifically, the measurement device 1 calculates the amplitude ratio RT between the deflection amount T_{p_Estd_lp} (t) and the deflection amount T_{p_std_lp}(t) in a predetermined interval using Formula (66) described above. Then, as expressed in Formula (67) described above, the measurement device 1 replaces the interval of the product R_{T}T_{p_std_lp}(t) of the amplitude ratio RT thus calculated and the deflection amount T_{p_std_lp}(t) in which an absolute value of the product R_{T}T_{p_std_lp}(t) is higher than the absolute value of the constant term c₀ with the constant term c₀, and thus, calculates the offset T_{p_offset_std} (t).

Then, in the step S1206, as expressed in Formula (68) described above, the measurement device 1 adds the product of the coefficient cᵢ of the linear term calculated in the step S1203 and the deflection amount T_{p_std}(t) as the first deflection amount calculated in the step S110 shown in FIG. 25 to the offset T_{p_offset_std}(t) calculated in the step S1205 to calculate the deflection amount T_{p_EOstd} (t) as the static response.

### 1-4. Configuration of Observation Device, Measurement Device, and Monitoring Device

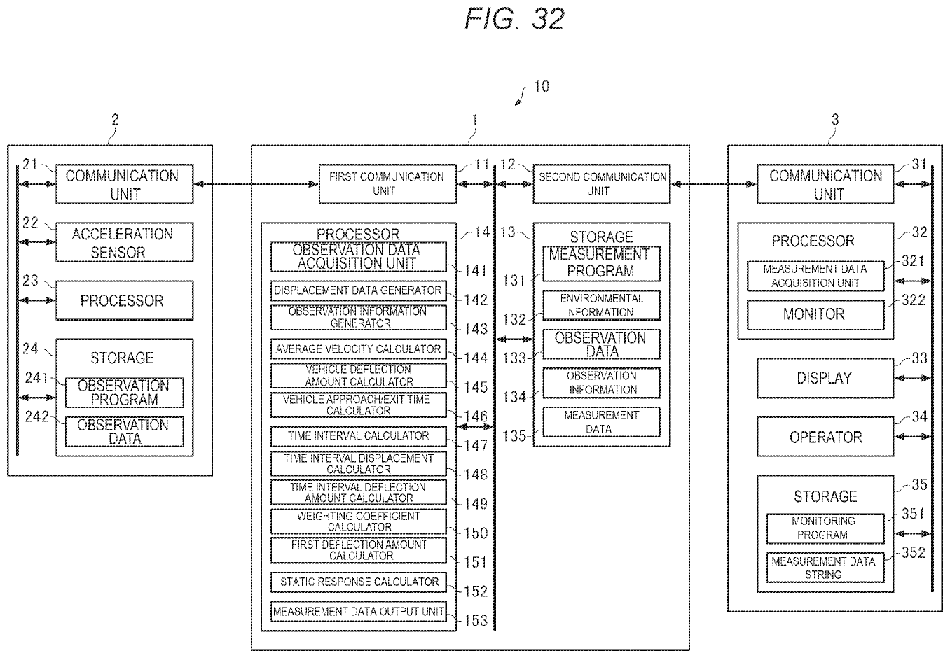

FIG. 32 is a diagram showing a configuration example of the sensor 2 as the observation device, the measurement device 1, and the monitoring device 3.

As shown in FIG. 32, the sensor 2 is provided with a communication unit 21, an acceleration sensor 22, a processor 23, and a storage 24.

The storage 24 is a memory which stores a variety of programs, data, and so on for the processor 23 to perform computational processing and control processing. Further, the storage 24 stores a program, data, and so on for the processor 23 to realize a predetermined application function.

The acceleration sensor 22 detects acceleration generated in directions of three axes.

The processor 23 executes an observation program 241 stored in the storage 24 to thereby control the acceleration sensor 22, generate observation data 242 based on the acceleration detected by the acceleration sensor 22, and then store the observation data 242 thus generated into the storage 24. In the present embodiment, the observation data 242 are the acceleration data a(k).

The communication unit 21 transmits the observation data 242 stored in the storage 24 to the measurement device 1 due to the control by the processor 23.

As shown in FIG. 32, the measurement device 1 is provided with a first communication unit 11, a second communication unit 12, a storage 13, and a processor 14.

The first communication unit 11 receives the observation data 242 from the sensor 2, and then outputs the observation data 242 thus received to the processor 14. As described above, the observation data 242 are the acceleration data a(k).

The storage 13 is a memory which stores a program, data, and so on for the processor 14 to perform computational processing and control processing. Further, the storage 13 stores a variety of programs, data, and so on for the processor 14 to realize a predetermined application function. Further, it is possible for the processor 14 to receive the variety of programs, the data, and so on via a communication network 4 and store them into the storage 13.

The processor 14 generates measurement data 135 based on the observation data 242 received by the first communication unit 11 and the environmental information 132 stored in advance in the storage 13, and then makes the storage 13 store the measurement data 135 thus generated.

In the present embodiment, the processor 14 executes a measurement program 131 stored in the storage 13 to thereby function as an observation data acquisition unit 141, a displacement data generator 142, an observation information generator 143, an average velocity calculator 144, a vehicle deflection amount calculator 145, a vehicle approach/exit time calculator 146, a time interval calculator 147, a time interval displacement calculator 148, a time interval deflection amount calculator 149, a weighting coefficient calculator 150, a first deflection amount calculator 151, a static response calculator 152, and a measurement data output unit 153. In other words, the processor 14 includes the observation data acquisition unit 141, the displacement data generator 142, the observation information generator 143, the average velocity calculator 144, the vehicle deflection amount calculator 145, the vehicle approach/exit time calculator 146, the time interval calculator 147, the time interval displacement calculator 148, the time interval deflection amount calculator 149, the weighting coefficient calculator 150, the first deflection amount calculator 151, the static response calculator 152, and the measurement data output unit 153.

The observation data acquisition unit 141 obtains the observation data 242 received by the first communication unit 11, and then stores them into the storage 13 as observation data 133. In other words, the observation data acquisition unit 141 performs the processing in the observation data acquisition step S10 in FIG. 25.

The displacement data generator 142 reads out the observation data 133 stored in the storage 13, and then generates the displacement data u(t), which are first displacement data based on the acceleration as a physical quantity which is a response to an action on the observation points R of the plurality of axles of the railroad vehicle 6 moving on the upper structure 7, based on the acceleration data a(t) as the observation data 133. Specifically, the displacement data generator 142 integrates the acceleration data a(t) as the observation data 133 to generate the velocity data v(t) as expressed in Formula (1), and further, integrates the velocity data v(t) to generate the displacement data u(t) as expressed in Formula (2). In other words, the displacement data generator 142 performs the processing in the displacement data generation step S20 in FIG. 25, specifically, the processing in the steps S201, S202 in FIG. 26.

The observation information generator 143 generates the observation information including the approach time tᵢ and the exit time tₒ with respect to the upper structure 7 of the railroad vehicle 6. In the present embodiment, the measurement device 143 generates the observation information 134 including the number of vehicles C_{T} in addition to the approach time tᵢ and the exit time tₒ based on the displacement data u(t) generated by the displacement data generator 142, and makes the storage 13 store the observation information 134. Specifically, first, the observation information generator 143 performs the fast Fourier transformation processing on the displacement data u(t) to calculate the power spectral density, and calculates the peak of the power spectral density as the basic frequency fᵤ₍ₜ₎ of the vibration component. Then, the measurement device 143 calculates the moving average interval t_{MA} using Formula (3) described above from the time interval ΔT of the samples of the displacement data u(t) and the basic frequency fᵤ₍ₜ₎ thus calculated, and then performs the moving average processing on the displacement data u(t) to calculate the displacement data uₗₚ(t) in which the vibration component is reduced using Formula (4) described above. Then, the observation information generator 143 differentiates the displacement data uₗₚ(t) to calculate the velocity data vₗₚ(t) using Formula (5) described above. Then, the observation information generator 143 calculates the peak time in the head negative region of the velocity data vₗₚ(t) as the approach time tᵢ. Then, the observation information generator 143 calculates the peak time in the rearmost positive region of the velocity data vₗₚ(t) as the exit time to. Then, the observation information generator 143 calculates the difference between the exit time tₒ and the approach time tᵢ as the passage time tₛ. Then, the observation information generator 143 calculates an integer most approximate to a number obtained by subtracting 1 from the product tₛfᵤ₍ₜ₎ of the passage time tₛ and the basic frequency fᵤ₍ₜ₎ as the number of vehicles C_{T} of the railroad vehicle 6. Then, the observation information generator 143 generates the observation information including the approach time tᵢ, the exit time to, the passage time tₛ, and the number of vehicles C_{T}. In other words, the observation information generator 143 performs the processing in the observation information generation step S30 in FIG. 25, specifically, the processing in the steps S301 through S308 in FIG. 27.

The average velocity calculator 144 calculates the average velocity vₐ of the railroad vehicle 6 based on the observation information 134 stored in the storage 13, and the environmental information 132 including the dimensions of the railroad vehicle 6 and the dimensions of the upper structure 7 prepared in advance and stored in the storage 13. Specifically, the average velocity calculator 144 calculates the distance D_{wa}(a_{w}(C_{T},a_{T}(C_{T}))) from the head axle to the rearmost axle of the railroad vehicle 6 using Formula (11) described above based on the environmental information 132. Further, the average velocity calculator 144 calculates the length L_{B} of the upper structure 7 as a distance from the approach end to the exit end of the upper structure 7 based on the environmental information 132. Then, the average velocity calculator 144 calculates the average velocity vₐ of the railroad vehicle 6 using Formula (12) described above based on the approach time tᵢ and the exit time tₒ included in the observation information 134, the distance D_{wa}(a_{w}(C_{T},a_{T}(C_{T}))), and the length L_{B} of the upper structure 7. In other words, the average velocity calculator 144 performs the processing in the average velocity calculation step S40 in FIG. 25, specifically, the processing in the steps S401, S402, and S403 in FIG. 28.

The vehicle deflection amount calculator 145 calculates the deflection amount C_{std}(Cₘ,t) of the upper structure 7 by each of the vehicles of the railroad vehicle 6 based on the approximation formula of the deflection of the upper structure 7 as Formula (35) described above, the observation information 134 stored in the storage 13, and the environmental information 132 stored in the storage 13. In the present embodiment, the vehicle deflection amount calculator 145 calculates the deflection amount C_{std}(Cₘ,t) based further on the average velocity vₐ of the railroad vehicle 6 calculated by the average velocity calculator 144.

Specifically, first, the vehicle deflection amount calculator 145 calculates the distance D_{wa}(a_{w}(Cₘ,n)) from the head axle of the railroad vehicle 6 to the n-th axle of the Cₘ-th vehicle using Formula (10) described above based on the environmental information 132. Then, the vehicle deflection amount calculator 145 calculates the time tₓₙ necessary for any of the axles of the railroad vehicle 6 to reach the position Lₓ of the observation point R from the approach end of the upper structure 7 with Formula (37) described above using the position Lₓ of the observation point R included in the environmental information 132 and the average velocity vₐ. Further, the vehicle deflection amount calculator 145 calculates the time tin necessary for any of the axles of the railroad vehicle 6 to pass through the upper structure 7 with Formula (38) described above using the length L_{B} of the upper structure 7 as a distance from the approach end to the exit end of the upper structure 7, and the average velocity vₐ. Further, the vehicle deflection amount calculator 145 calculates the time to(Cₘ,n) when the n-th axle of the Cₘ-th vehicle of the railroad vehicle 6 with Formula (39) described above using the approach time tᵢ included in the observation information 134, the distance D_{wa}(a_{w}(Cₘ,n)), and the average velocity vₐ. Then, the vehicle deflection amount calculator 145 calculates the deflection amount w_{std}(a_{w}(Cₘ,n),t) of the upper structure 7 by the n-th axle of the Cₘ-th vehicle with Formula (40) described above using an approximation formula of the deflection of the upper structure 7 as Formula (35) described above, the time tₓₙ, the time tₗₙ, and the time t₀(Cₘ,n). Then, the vehicle deflection amount calculator 145 calculates the deflection amounts C_{std}(Cₘ,t) of the upper structure 7 by the Cₘ-th vehicle with Formula (42) described above using the deflection amounts w_{std}(a_{w}(Cₘ,n),t). In other words, the vehicle deflection amount calculator 145 performs the processing in the vehicle deflection amount calculation step S50 in FIG. 25, specifically, the processing in the steps S501 through S506 in FIG. 29.

The vehicle approach/exit time calculator 146 calculates the approach times t₀(1,1) through t₀(C_{T},1) and the exit times t₀(1,a_{T}(1)) through t₀(C_{T},a_{T}(C_{T})) of the respective vehicles of the railroad vehicle 6 with respect to the upper structure 7 based on the observation information 134 stored in the storage 13 and the environmental information 132 stored in the storage 13. Specifically, the vehicle approach/exit time calculator 146 adds the value obtained by dividing the distance D_{wa}(a_{w}(Cₘ,1)) from the head axle of the 1-st vehicle to the head axle of the Cₘ-th vehicle by the average velocity vₐ to the approach time tᵢ to thereby calculate the approach time t₀(Cₘ,1) of the Cₘ-th vehicle to the upper structure 7 as expressed in Formula (47) described above with respect to each of Cₘ=1 through C_{T}. Further, the vehicle approach/exit time calculator 146 adds the value obtained by dividing the sum of the distance D_{wa}(a_{w}(Cₘ,a_{T}(Cₘ))) from the head axle of the 1-st vehicle to the rearmost axle of the Cₘ-th vehicle and the length L_{B} of the upper structure 7 by the average velocity vₐ to the approach time tᵢ to thereby calculate the distance D_{wa}(a_{w}(Cₘ,a_{T}(Cₘ))) of the Cₘ-th vehicle from the upper structure 7 as expressed in Formula (48) described above with respect to each of Cₘ=1 through C_{T}. In other words, the vehicle approach/exit time calculator 146 performs the processing in the vehicle approach/ext time calculation step S60 in FIG. 25, specifically, the processing in the steps S601, S602 in FIG. 30.

The time interval calculator 147 calculates the time intervals t₁ through t_{2CT-1} divided by the plurality of times tsort(1) through tsort(2C_{T}) obtained by sorting the approach times t₀(1,1) through t₀(C_{T},1) and the exit times t₀(1,a_{T}(1)) through to(C_{T},a_{T}(C_{T})) calculated by the vehicle approach/exit time calculator 146 by time. In other words, the time interval calculator 147 performs the processing in the time interval calculation step S70 in FIG. 25.

The time interval displacement calculator 148 calculates the amplitude amount u_{M}(n) of the displacement data u(t) in each of the time intervals t₁ through t_{2CT-1} calculated by the time interval calculator 147. The amplitude amount u_{M}(n) is the average value uₐ(n) or the integrated value uₛ(n). The time interval displacement calculator 148 calculates the amplitude amount u_{M}(n) using Formula (49) described above when the amplitude amount u_{M}(n) is the average value uₐ(n), or calculates the amplitude amount u_{M}(n) using Formula (50) described above when the amplitude amount u_{M}(n) is the integrated value uₛ(n). In other words, the time interval displacement calculator 148 performs the processing in the time interval displacement calculation step S80 in FIG. 25.

The time interval deflection amount calculator 149 calculates the amplitude amount C_{std_M}(n,Cₘ) of the deflection amount C_{std}(Cₘ,t) of the upper structure 7 by each of the vehicles in each of the time intervals t1 through t_{2CT-1} calculated by the time interval calculator 147. The amplitude amount C_{std_M}(n,Cₘ) is the average value C_{std_a}(n,Cₘ) or the integrated value C_{std_s}(n, Cₘ). The time interval deflection amount calculator 149 calculates the amplitude amount C_{std_M}(n,Cₘ) using Formula (51) described above when the amplitude amount C_{std_M}(n,Cₘ) is the average value C_{std_a}(r,Cₘ) or calculates the amplitude amount C_{std_M}(n,Cₘ) using Formula (52) described above when the amplitude amount C_{std_M}(n,Cₘ) is the integrated value C_{std_s} (n, Cₘ). In other words, the time interval deflection amount calculator 149 performs the processing in the time interval deflection amount calculation step S90 in FIG. 25.

The weighting coefficient calculator 150 calculates the weighting coefficients P_{C}_{ₘ} to the respective vehicles assuming that the sum of products of the amplitude amounts C_{std_M}(n,Cₘ) of the deflection amounts C_{std}(Cₘ,t) by the respective vehicles in each of the time intervals t₁ through t_{2CT-1} and the weighting coefficients P_{C}_{ₘ} with respect to the respective vehicles is equal to the amplitude amount u_{M}(n) of the displacement data u(t) in each of the time intervals t₁ through t_{2CT-1}. Specifically, when the amplitude amount u_{M}(n) calculated by the time interval displacement calculator 148 and the amplitude amount C_{std_M}(n,Cₘ) calculated by the time interval deflection amount calculator 149 are the average value uₐ(n) and the average value C_{std_a}(n,Cₘ) f respectively, the weighting coefficient calculator 150 calculates the weighting coefficients P_{C}_{ₘ} using Formula (54) described above. Further, when the amplitude amount u_{M}(n) calculated by the time interval displacement calculator 148 and the amplitude amount C_{std_M}(n,Cₘ) calculated by the time interval deflection amount calculator 149 are the integrated value uₛ(n) and the integrated value C_{std_s}(n,Cₘ), respectively, the weighting coefficient calculator 150 calculates the weighting coefficients P_{C}_{ₘ} using Formula (55) described above. In other words, the weighting coefficient calculator 150 performs the processing in the weighting coefficient calculation step S100 in FIG. 25.

The first deflection amount calculator 151 calculates the deflection amount T_{p_std}(t) as the first deflection amount of the upper structure 7 by the railroad vehicle 6 using the sum of the products of the weighting coefficients P_{C}_{ₘ} with respect to the respective vehicles of the railroad vehicle 6 calculated by the weighting coefficient calculator 150, and the deflection amounts C_{std}(Cₘ,t) of the upper structure 7 by the respective vehicles calculated by the vehicle deflection amount calculator 145 as expressed in Formula (45) described above. In other words, the first deflection amount calculator 151 performs the processing in the first deflection amount calculation step S110 in FIG. 25.

The static response calculator 152 calculates the deflection amount T_{p_Eostd}(t) as the static response when the railroad vehicle 6 moves on the upper structure 7 based on the displacement data u(t) generated by the displacement data generator 142 and the deflection amount T_{p_std}(t) calculated by the first deflection amount calculator 151. Specifically, first, the static response calculator 152 performs the filter processing on the displacement data u(t) as the first displacement data to calculate the displacement data uₗₚ(t) as the second displacement data in which the vibration component is reduced. For example, the static response calculator 152 performs the fast Fourier transformation processing on the displacement data u(t) to calculate the power spectral density, and calculates the peak of the power spectral density as the basic frequency fᵤ₍ₜ₎ of the vibration component. Then, the static response calculator 152 calculates the moving average interval t_{MA} using Formula (3) described above from the time interval ΔT of the samples of the displacement data u(t) and the basic frequency fᵤ₍ₜ₎ thus calculated, and then performs the moving average processing on the displacement data u(t) to calculate the displacement data uₗₚ(t) in which the vibration component is reduced using Formula (4) described above.

Then, the static response calculator 152 performs the filter processing on the deflection amount T_{p_std}(t) as the first deflection amount to calculate the deflection amount T_{p_std_lp}(t) as the second deflection amount in which the vibration component is reduced. For example, the static response calculator 152 performs the fast Fourier transformation processing on the deflection amount T_{p_std}(t) to calculate the power spectral density, and calculates the peak of the power spectral density as the basic frequency F_{M} of the vibration component. Then, the static response calculator 152 calculates the moving average interval k_{mM} using Formula (57) described above from the time interval ΔT and the basic frequency F_{M}, and then performs the moving average processing on the deflection amount T_{p_std}(t) to calculate the deflection amount T_{p_std_lp}(t) in which the vibration component is reduced using Formula (58) described above.

Then, the static response calculator 152 approximates the displacement data uₗₚ(t) with the linear function of the deflection amount T_{p_std_lp}(t) to calculate the coefficient cᵢ of the linear term and the constant term c₀ of the linear function. For example, the static response calculator 152 approximates the displacement data uₗₚ(t) with the linear function of the deflection amount T_{p_std_lp}(t) as expressed in Formula (59) described above, and calculates the coefficient cᵢ of the linear term and the constant term c₀ with Formula (61) and Formula (62) described above using the least-square method.

Then, the static response calculator 152 calculates the deflection amount T_{p_Estd_lp}(t) as the third deflection amount based on the coefficient cᵢ of the linear term and the constant term c₀, and the deflection amount T_{p_std_lp}(t) as the second deflection amount. For example, the static response calculator 152 calculates the deflection amount T_{Estd_lp}(t) which is the product c₁T_{p_std_lp}(t) of the coefficient c₁ of the linear term and the deflection amount T_{p_std_lp}(t) in the interval before the approach time tᵢ and the interval after the exit time to, and which is the sum of the product c₁T_{p_std_lp}(t) and the constant term c₀ in the interval between the approach time tᵢ and the exit time tₒ as expressed in Formula (63) described above.

Then, the static response calculator 152 calculates the offset T_{p_offset_std} (t) based on the constant term c₀, the deflection amount T_{p_std_lp}(t), and the deflection amount T_{p_Estd_lp}(t). For example, the static response calculator 152 calculates the amplitude ratio RT between the deflection amount T_{p_Estd_lp}(t) and the deflection amount T_{p_std_lp}(t) in a predetermined interval using Formula (66) described above. Then, as expressed in Formula (67) described above, the static response calculator 152 replaces the interval of the product R_{T}T_{p_std_lp}(t) of the amplitude ratio RT thus calculated and the deflection amount T_{p_std_lp}(t) in which an absolute value of the product R_{T}T_{p_std_lp}(t) is higher than the absolute value of the constant term c₀ with the constant term c₀, and thus, calculates the offset T_{p_offset_std} t).

Lastly, as expressed in Formula (68) described above, the static response calculator 152 adds the product of the coefficient cᵢ of the linear term and the deflection amount T_{p_std}(t) to the offset T_{p_offset_std}W to calculate the deflection amount T_{p_EOstd} (t) as the static response. In other words, the static response calculator 152 performs the processing in the static response calculation step S120 in FIG. 25, specifically, the processing in the steps S1201 through S1206 in FIG. 31.

The weighting coefficients P_{C}_{ₘ} to the respective vehicles, and the deflection amount T_{p_EOstd}(t) as the static response are stored in the storage 13 as at least a part of the measurement data 135. The measurement data 135 can include the displacement data u(t), uₗₚ(t), the deflection amounts T_{p_std}(t), T_{p_std_lp}(t), T_{p_std_lp}(t), and so on in addition to the weighting coefficients P_{C}_{ₘ} and the deflection amount T_{p_EOstd} (t).

The measurement data output unit 153 reads out the measurement data 135 stored in the storage 13, and then outputs the measurement data 135 to the monitoring device 3. Specifically, due to the control of the measurement data output unit 153, the second communication unit 12 transmits the measurement data 135 stored in the storage 13 to the monitoring device 3 via the communication network 4. In other words, the measurement data output unit 153 performs the processing in the measurement data output step S130 in FIG. 25.

As described above, the measurement program 131 is a program of making the measurement device 1 as a computer execute the procedures of the flowchart shown in FIG. 25.

As shown in FIG. 32, the monitoring device 3 is provided with a communication unit 31, a processor 32, a display 33, an operator 34, and a storage 35.

The communication unit 31 receives the measurement data 135 from the measurement device 1, and then outputs the measurement data 135 thus received to the processor 32.

The display 33 displays a variety of types of information due to the control by the processor 32. The display 33 can be, for example, a liquid crystal display or an organic EL display. EL is an abbreviation for Electro Luminescence.

The operator 34 outputs operation data corresponding to operations by the user to the processor 32. The operator 34 can be an input device such as a mouse, a keyboard, or a microphone.

The storage 35 is a memory which stores a variety of programs, data, and so on for the processor 32 to perform computational processing and control processing. Further, the storage 35 stores a program, data, and so on for the processor 32 to realize a predetermined application function.

The processor 32 obtains the measurement data 135 received by the communication unit 31, evaluates a change over time in displacement of the upper structure 7 based on the measurement data 135 thus obtained to generate evaluation information, and then makes the display 33 display the evaluation information thus generated.

In the present embodiment, the processor 32 executes a monitoring program 351 stored in the storage 35 to thereby function as a measurement data acquisition unit 321 and a monitor 322. In other words, the processor 32 includes the measurement data acquisition unit 321 and the monitor 322.

The measurement data acquisition unit 321 obtains the measurement data 135 received by the communication unit 31, and then adds the measurement data 135 thus obtained to a measurement data string 352 stored in the storage 35.

The monitor 322 statistically evaluates the change over time in the deflection amount of the upper structure 7 based on the measurement data string 352 stored in the storage 35. Then, the monitor 322 generates the evaluation information representing an evaluation result, and then makes the display 33 display the evaluation information thus generated. It is possible for the user to monitor the state of the upper structure 7 based on the evaluation information displayed by the display 33.

It is possible for the monitor 322 to perform processing such as monitoring of the railroad vehicle 6 or abnormality determination of the upper structure 7 based on the measurement data string 352 stored in the storage 35.

Further, the processor 32 transmits information for adjusting the operating status of the measurement device 1 or the sensor 2 to the measurement device 1 via the communication unit 31 based on the operation data output from the operator 34. In the measurement device 1, the operating status is adjusted in accordance with the information received via the second communication unit 12. Further, the measurement device 1 transmits the information for adjusting the operating status of the sensor 2, which is received via the second communication unit 12, to the sensor 2 via the first communication unit 11. In the sensor 2, the operating status is adjusted in accordance with the information received via the communication unit 21.

It should be noted that in the processors 14, 23, and 32, for example, the functions of respective sections can each be realized by individual hardware, or the functions of the respective sections can also be realized by integrated hardware. For example, it is possible for the processors 14, 23, and 32 to include hardware, and it is possible for the hardware to include at least one of a circuit for processing a digital signal and a circuit for processing an analog signal. The processors 14, 23, and 32 can each be a CPU, a GPU, a DSP, or the like. CPU is an abbreviation for Central Processing Unit, GPU is an abbreviation for Graphics Processing Unit, and DSP is an abbreviation for Digital Signal Processor. Further, the processors 14, 23, and 32 can each be configured as a custom IC such as an ASIC to thereby realize the functions of the respective sections, or it is possible to realize the functions of the respective sections by a CPU and an ASIC. ASIC is an abbreviation for Application Specific Integrated Circuit, and IC is an abbreviation for Integrated Circuit.

Further, the storages 13, 24, and 35 are each formed of a recording medium such as a variety of IC memories such as a ROM, a flash ROM, or a RAM, a hard disk, or a memory card. ROM is an abbreviation for Read Only Memory, RAM is an abbreviation for Random Access Memory, and IC is an abbreviation for Integrated Circuit. It is possible for each of the storages 13, 24, and 35 to include a nonvolatile information storage device such as a computer-readable device or a computer readable medium, and it is possible for a variety of programs and data to be stored in that information storage device. The information storage device can be an optical disc such as an optical disc DVD or a CD, a hard disk drive, or a variety of types of memories such as a card-type memory or a ROM.

It should be noted that although just one sensor 2 is illustrated in FIG. 32, it is possible for each of two or more sensors 2 to generate the observation data 242 and then transmit the observation data 242 to the measurement device 1. In this case, the measurement device 1 receives the plurality of observation data 242 transmitted from the plurality of sensors 2 to generate the plurality of measurement data 135, and then transmits the plurality of measurement data 135 to the monitoring device 3. Further, the monitoring device 3 receives the plurality of measurement data 135 transmitted from the measurement device 1, and then monitors the state of the plurality of upper structures 7 based on the plurality of measurement data 135 thus received.

### 1-5. Functions and Advantages

In the measurement method according to the first embodiment described hereinabove, the measurement device 1 generates the displacement data u(t) based on the acceleration data a(t) output from the sensor 2, and then calculates the deflection amount C_{std}(Cₘ,t) of the upper structure 7 by each of the vehicles of the railroad vehicle 6 based on Formula (35) as the approximation formula of the deflection based on the structure model reflecting the structure of the upper structure 7 of the bridge 5, the observation information, and the environmental information. Further, the measurement device 1 calculates the weighting coefficient P_{C}_{ₘ} as the coefficient correlated with the weight of each of the vehicles of the railroad vehicle 6 which moves on the upper structure 7 with relatively simple processing using the displacement data u(t) and the deflection amount C_{std}(Cₘ,t). Therefore, according to the measurement method related to the first embodiment, it is possible for the measurement device 1 to calculate the weighting coefficients P_{C}_{ₘ} to the respective vehicles with the processing relatively small in calculation amount without performing processing extremely large in calculation amount such as estimating unknown parameters of a theoretical analysis model from the acceleration data a(t) using an inverse analysis method.

Further, according to the measurement method related to the first embodiment, since the velocity of the railroad vehicle 6 slightly but hardly changes in reality, it is possible for the measurement device 1 to dramatically reduce the calculation amount while keeping the calculation accuracy of the deflection amount T_{std}(t) by calculating the deflection amount T_{std}(t) based on the average velocity vₐ assuming that the railroad vehicle 6 constantly runs at the average velocity vₐ.

Further, according to the measurement method related to the first embodiment, it is possible for the measurement device 1 to calculate the average velocity vₐ of the railroad vehicle 6 using simple calculation with Formula (13) based on the acceleration data a(t) output from the sensor 2 without directly measuring the average velocity vₐ of the railroad vehicle 6.

Further, according to the measurement method related to the first embodiment, it is possible to calculate the deflection amount T_{p_std}(t) of the upper structure 7 when the railroad vehicle 6 moves on the upper structure 7 with the processing relatively small in calculation amount using the sum of the products of the weighting coefficients P_{C}_{ₘ} to the respective vehicles and the deflection amounts C_{std}(Cₘ,t) of the upper structure 7 by the respective vehicles of the railroad vehicle 6.

Further, in the measurement method according to the first embodiment, the measurement device 1 calculates the time intervals t₁ through t_{2CT-1} divided by the plurality of times tsort(1) through tsort(2C_{T}) obtained by sorting the approach times t₀(1,1) through t₀(C_{T}, 1) and the exit times t₀(1,a_{T}(1)) through t₀(C_{T},a_{T}(C_{T})) of each of the vehicles of the railroad vehicle 6 with respect to the upper structure 7 by time, and then accurately calculates the weighting coefficient P_{C}_{ₘ} to each of the vehicles assuming that the sum of the products of the amplitude amounts C_{std_M}(n,Cₘ) of the deflection amounts C_{std}(Cₘ,t) by each of the vehicles in the respective time intervals t₁ through t_{2CT-1} is equal to the amplitude amounts u_{M}(n) of the displacement data u(t) in the respective time intervals t₁ through t_{2CT-1}. Then, the measurement device 1 calculates the deflection amount T_{p_std}(t) of the upper structure 7 by the railroad vehicle 6 based on the weighting coefficients P_{C}_{ₘ} accurately calculated. Therefore, according to the measurement method related to the first embodiment, it is possible for the measurement device 1 to accurately calculate the deflection amount T_{p_std}(t) of the upper structure 7 when the railroad vehicle 6 moves on the upper structure 7 not using the same coefficient to all of the vehicles of the railroad vehicle 6, but using the weighting coefficients P_{C}_{ₘ} high in accuracy corresponding to the loads by the respective vehicles.

Further, in the measurement method according to the first embodiment, the measurement device 1 calculates the static response when the railroad vehicle 6 moves on the upper structure 7 based on the displacement data u(t) and the deflection amount T_{p_std}(t). Therefore, according to the measurement method related to the first embodiment, it is possible for the measurement device 1 to accurately calculate the static response when the railroad vehicle 6 moves on the upper structure 7 with the processing relatively small in calculation amount.

Further, in the measurement method according to the first embodiment, the measurement device 1 performs the filter processing on the displacement data u(t) to calculate the displacement data uₗₚ(t), performs the filter processing on the deflection amount T_{p_std}(t) to calculate the deflection amount T_{p_std_lp}(t), approximates the displacement data uₗₚ(t) with the linear function of the deflection amount T_{p_std_lp}(t), calculates the coefficient c₁ of the linear term and the constant term c₀ of that linear function, calculates the deflection amount T_{p_Estd_lp}(t) based on the coefficient c₁ of the linear term, the constant term c₀, and the deflection amount T_{p_std_lp}(t), calculates the offset T_{p_offset_std}(t) based on the constant term c₀ and the deflection amounts T_{p_std_lp}(t), T_{p_std_lp}(t), and adds the product of the coefficient cᵢ of the linear term and the deflection amount T_{p_std}(t) to the offset T_{p_offset_std} (t) to calculate the deflection amount T_{p_EOstd} (t) as the static response. Therefore, according to the measurement method related to the first embodiment, by the measurement device 1 approximating the displacement data uₗₚ(t) in which the vibration component included in the displacement data u(t) is reduced with the linear function of the deflection amount T_{p_std_lp}(t) in which the vibration component included in the deflection amount T_{p_std}(t) is reduced, the calculation accuracy of the coefficient c₁ of the linear term and the constant term c₀ of the linear function increases. Further, the product of the coefficient c₁ of the linear term and the deflection amount T_{p_std}(t) corresponds to the displacement of the upper structure 7 proportional to the load by the railroad vehicle 6, and the offset T_{p_offset_std} (t) corresponds to a displacement nonproportional to the load by the railroad vehicle 6 such as a play or floating of the upper structure 7. Therefore, according to the measurement method related to the first embodiment, by adding the product of the coefficient cᵢ of the linear term and the deflection amount T_{p_std}(t) to the offset T_{p_offset_std} (t), it is possible to accurately calculate the static response.

### 2. Second Embodiment

Regarding the second embodiment, different contents from those in the first embodiment will hereinafter be mainly described while denoting substantially the same constituents as those in the first embodiment by the same reference numerals, and omitting or simplifying the description duplicated with the first embodiment.

In the second embodiment, the measurement device 1 calculates a matrix C_{std_X} representing whether the vehicles are moving on the upper structure 7 in the time intervals t₁ through t_{2CT-1} based on the deflection amount C_{std}(Cₘ,t) of the upper structure 7 by the vehicles of the railroad vehicle 6 in the time intervals t₁ through t_{2CT-1}. The matrix C_{std_X} is a (2C_{T}−1)×C_{T} matrix, and is expressed as Formula (69).

$${C}_{std \_ X} = ( \begin{matrix}{C}_{std \_ X} ( 1 , 1 ) & {C}_{std \_ X} ( 1 , 2 ) & … & {C}_{std \_ X} ( 1 , {C}_{T} ) \\ {C}_{std \_ X} ( 2 , 1 ) & {C}_{std \_ X} ( 2 , 2 ) & … & {C}_{std \_ X} ( 2 , {C}_{T} ) \\ ⋮ & ⋮ & ⋮ & ⋮ \\ {C}_{std \_ X} ( 2 {C}_{T} - 1 , 1 ) & {C}_{std \_ X} ( 2 {C}_{T} - 1 , 2 ) & … & {C}_{std \_ X} ( 2 {C}_{T} - 1 , {C}_{T} )\end{matrix} ) \qquad ( 69 )$$

An element C_{std_x}(n,Cₘ) in the n-th row and the Cₘ-th column of the matrix C_{std_X} expressed as Formula (69) is calculated with Formula (70). The character n denotes integers no lower than 1 and no higher than 2C_{T}−1, and Cₘ denotes integers no lower than 1 and no higher than CT.

$${C}_{std \_ X} ( n , {C}_{m} ) \{ \begin{matrix}= 0 if {\sum }_{t = {t}_{sort} ( n )}^{{t}_{sort} ( n + 1 )} {C}_{std} ( {C}_{m} , t ) = 0 \\ = 1 if {\sum }_{t = {t}_{sort} ( n )}^{{t}_{sort} ( n + 1 )} {C}_{std} ( {C}_{m} , t ) \neq 0\end{matrix} \qquad ( 70 )$$

Formula (70) shows the fact that the element C_{std_X}(n,Cₘ) is 1 when the integrated value of the deflection amounts C_{std}(Cₘ,t) by the Cₘ-th vehicle in the time interval tₙ from the time tsort(n) to the time tsort(n+1) is not 0, and the element C_{std_X}(n,Cₘ) is 0 when that integrated value is 0. In other words, the matrix C_{std_X} shows the fact that the Cₘ-th vehicle is moving on the upper structure 7 in the time interval tₙ when the element C_{std_X}(n,Cₘ) is 1, and the Cₘ-th vehicle is not moving on the upper structure 7 in the time interval tₙ when the element C_{std_X}(n,Cₘ) is 0. In other words, in the matrix C_{std_X}, the CT elements C_{std_X}(n,1) through C_{std_X}(n,C_{T}) in the n-th row show whether the 1-st through C_{T}-th vehicles are moving on the upper structure 7 in the time interval tₙ.

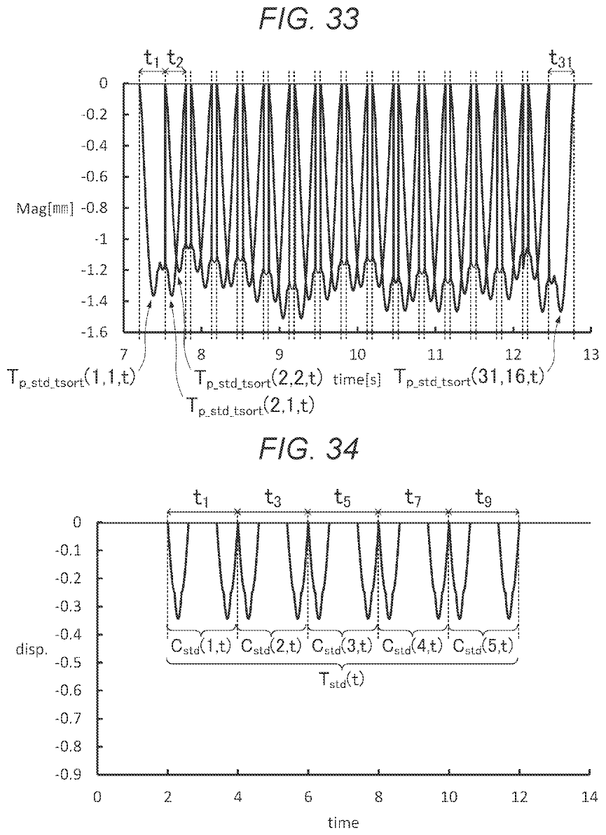

Further, as expressed in Formula (71), assuming the deflection amount C_{p_std}(Cₘ,t) by the Cₘ-th vehicle weighted by the load in the time interval tₙ from the time tsort(n) to the time tsort(n+1) as the deflection amount C_{p_stdt_sort}(n,Cₘ,t), the influence of each of the vehicles on the deflection amount T_{p_std}(t) by the railroad vehicle 6 is understood from the deflection amount C_{p_std_tsort}(n,Cₘ,t). FIG. 33 shows an example of the deflection amount C_{p_std_tsort}(n, Cₘ, t).

$${C}_{p \_ std \_ {t}_{sort}} ( n , {C}_{m} , t ) = \{ \begin{matrix}0 & if ( t < {t}_{sort} ( n ) ) \\ {C}_{{p}_{std}} ( {C}_{m} , t ) & if ( {t}_{sort} ( n ) \leq t \leq {t}_{sort} ( n + 1 ) ) \\ 0 & if ( {t}_{sort} ( n + 1 ) < t )\end{matrix} \qquad ( 71 )$$

A pattern of the matrix C_{std_X} expressed by Formula (69) described above changes in accordance with the relationship between the length L_{B} of the upper structure 7 and the dimensions of the railroad vehicle 6. For example, when the dimensions of the railroad vehicle 6 are C_{T}=5, L_{c}(Cₘ)=25 m, a_{T}(Cₘ)=4, La(a_{w}(Cₘ,1))=2.5 m, La(a_{w}(Cₘ,2))=2.5 m, La(a_{w}(Cₘ,3))=15 m, and La(a_{w}(Cₘ,4))=2.5 m, the matrix C_{std_X} when changing the length L_{B} of the upper structure 7 is expressed in Formulas (72) through (78).

Formula (72) expresses the matrix C_{std_X} when L_{B}=5 m is set. Formula (72) shows the fact that the head vehicle is moving in the time interval t₁, the 2-nd vehicle is moving in the time interval t₃, the 3-rd vehicle is moving in the time interval t₅, the 4-th vehicle is moving in the time interval t₇, and the rearmost vehicle is moving in the time interval t₉. Further, Formula (72) shows the fact that the time intervals t₂, t₄, t₆, and is do not exist since the time tsort(2) and the time tsort(3) are equal to each other, the time tsort(4) and the time tsort(5) are equal to each other, the time tsort(6) and the time tsort(7) are equal to each other, and the time tsort(8) and the time tsort(9) are equal to each other. FIG. 34 shows an example of the deflection amounts C_{std}(1,t) through C_{std}(5,t) by the respective vehicles and the deflection amount T_{std}(t) by the railroad vehicle 6 when L_{B}=5 m is set.

$${C}_{std \_ X} = ( \begin{matrix}1 & 0 & 0 & 0 & 0 \\ 0 & 0 & 0 & 0 & 0 \\ 0 & 1 & 0 & 0 & 0 \\ 0 & 0 & 0 & 0 & 0 \\ 0 & 0 & 1 & 0 & 0 \\ 0 & 0 & 0 & 0 & 0 \\ 0 & 0 & 0 & 1 & 0 \\ 0 & 0 & 0 & 0 & 0 \\ 0 & 0 & 0 & 0 & 1\end{matrix} ) \qquad ( 72 )$$

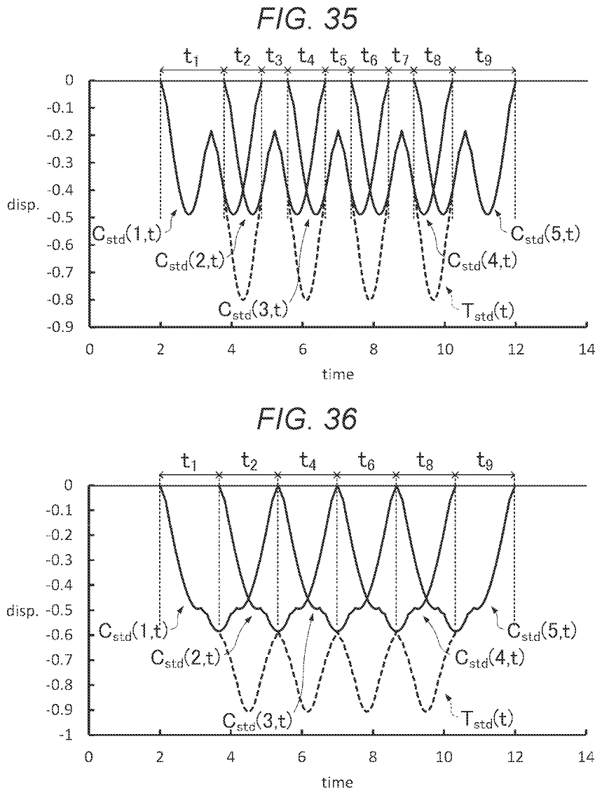

Formula (73) expresses the matrix C_{std_X} when L_{B}=20 m is set. Formula (73) shows the fact that the head vehicle is moving in the time interval t₁, the head vehicle and the 2-nd vehicle are moving in the time interval t₂, the 2-nd vehicle is moving in the time interval t₃, the 2-nd vehicle and the 3-rd vehicle are moving in the time interval t₄, the 3-rd vehicle is moving in the time interval t₅, the 3-rd vehicle and the 4-th vehicle are moving in the time interval t₆, the 4-th vehicle is moving in the time interval t₇, the 4-th vehicle and the rearmost vehicle are moving in the time interval t₅, and the rearmost vehicle is moving in the time interval t₉. FIG. 35 shows an example of the deflection amounts C_{std}(1,t) through C_{std}(5,t) by the respective vehicles and the deflection amount T_{std}(t) by the railroad vehicle 6 when L_{B}=20 m is set.

$${C}_{std \_ X} = ( \begin{matrix}1 & 0 & 0 & 0 & 0 \\ 1 & 1 & 0 & 0 & 0 \\ 0 & 1 & 0 & 0 & 0 \\ 0 & 1 & 1 & 0 & 0 \\ 0 & 0 & 1 & 0 & 0 \\ 0 & 0 & 1 & 1 & 0 \\ 0 & 0 & 0 & 1 & 0 \\ 0 & 0 & 0 & 1 & 1 \\ 0 & 0 & 0 & 0 & 1\end{matrix} ) \qquad ( 73 )$$

Formula (74) expresses the matrix C_{std_X} when L_{B}=30 m is set. Formula (74) shows the fact that the head vehicle is moving in the time interval t₁, the head vehicle and the 2-nd vehicle are moving in the time interval t₂, the 2-nd vehicle and the 3-rd vehicle are moving in the time interval t₄, the 3-rd vehicle and the 4-th vehicle are moving in the time interval t₆, the 4-th vehicle and the rearmost vehicle are moving in the time interval t₈, and the rearmost vehicle is moving in the time interval t₉. Further, Formula (74) shows the fact that the time intervals t₃, t₅, and t₇ do not exist since the time tsort(3) and the time tsort(4) are equal to each other, the time tsort(5) and the time tsort(6) are equal to each other, and the time tsort(7) and the time tsort(8) are equal to each other. FIG. 36 shows an example of the deflection amounts C_{std}(1,t) through C_{std}(5,t) by the respective vehicles and the deflection amount T_{std}(t) by the railroad vehicle 6 when L_{B}=30 m is set.

$${C}_{std \_ X} = ( \begin{matrix}1 & 0 & 0 & 0 & 0 \\ 1 & 1 & 0 & 0 & 0 \\ 0 & 0 & 0 & 0 & 0 \\ 0 & 1 & 1 & 0 & 0 \\ 0 & 0 & 0 & 0 & 0 \\ 0 & 0 & 1 & 1 & 0 \\ 0 & 0 & 0 & 0 & 0 \\ 0 & 0 & 0 & 1 & 1 \\ 0 & 0 & 0 & 0 & 1\end{matrix} ) \qquad ( 74 )$$

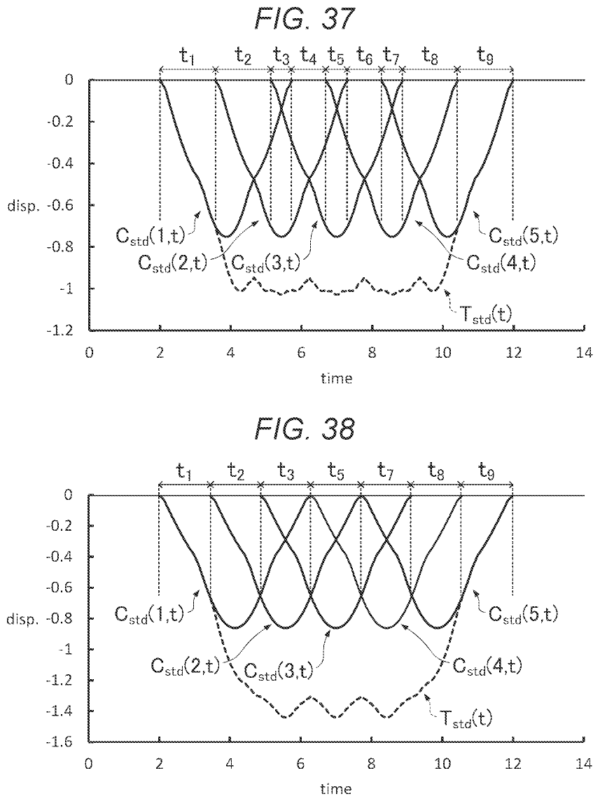

Formula (75) expresses the matrix C_{std_X} when L_{B}=40 m is set. Formula (75) shows the fact that the head vehicle is moving in the time interval t₁, the head vehicle and the 2-nd vehicle are moving in the time interval t₂, the head vehicle, the 2-nd vehicle, and the 3-rd vehicle are moving in the time interval t₃, the 2-nd vehicle and the 3-rd vehicle are moving in the time interval t₄, the 2-nd vehicle, the 3-rd vehicle, and the 4-th vehicle are moving in the time interval t₅, the 3-rd vehicle and the 4-th vehicle are moving in the time interval t₆, the 3-rd vehicle, the 4-th vehicle, and the rearmost vehicle are moving in the time interval t₇, the 4-th vehicle and the rearmost vehicle are moving in the time interval t₈, and the rearmost vehicle is moving in the time interval t₉. FIG. 37 shows an example of the deflection amounts C_{std}(1,t) through C_{std}(5,t) by the respective vehicles and the deflection amount T_{std}(t) by the railroad vehicle 6 when L_{B}=40 m is set.

$${C}_{std \_ X} = ( \begin{matrix}1 & 0 & 0 & 0 & 0 \\ 1 & 1 & 0 & 0 & 0 \\ 1 & 1 & 1 & 0 & 0 \\ 0 & 1 & 1 & 0 & 0 \\ 0 & 1 & 1 & 1 & 0 \\ 0 & 0 & 1 & 1 & 0 \\ 0 & 0 & 1 & 1 & 1 \\ 0 & 0 & 0 & 1 & 1 \\ 0 & 0 & 0 & 0 & 1\end{matrix} ) \qquad ( 75 )$$

Formula (76) expresses the matrix C_{std_X} when L_{B}=55 m is set. Formula (76) shows the fact that the head vehicle is moving in the time interval t₁, the head vehicle and the 2-nd vehicle are moving in the time interval t₂, the head vehicle, the 2-nd vehicle, and the 3-rd vehicle are moving in the time interval t₈, the 2-nd vehicle, the 3-rd vehicle, and the 4-th vehicle are moving in the time interval t₅, the 3-rd vehicle, the 4-th vehicle, and the rearmost vehicle are moving in the time interval t₇, the 4-th vehicle and the rearmost vehicle are moving in the time interval tₛ, and the rearmost vehicle is moving in the time interval t₉. Further, Formula (76) shows the fact that the time intervals t₄, t₆ do not exist since the time tsort(4) and the time tsort(5) are equal to each other, and the time tsort(6) and the time tsort(7) are equal to each other. FIG. 38 shows an example of the deflection amounts C_{std}(1,t) through C_{std}(5,t) by the respective vehicles and the deflection amount T_{std}(t) by the railroad vehicle 6 when L_{B}=55 m is set.

$${C}_{std \_ X} = ( \begin{matrix}1 & 0 & 0 & 0 & 0 \\ 1 & 1 & 0 & 0 & 0 \\ 1 & 1 & 1 & 0 & 0 \\ 0 & 0 & 0 & 0 & 0 \\ 0 & 1 & 1 & 1 & 0 \\ 0 & 0 & 0 & 0 & 0 \\ 0 & 0 & 1 & 1 & 1 \\ 0 & 0 & 0 & 1 & 1 \\ 0 & 0 & 0 & 0 & 1\end{matrix} ) \qquad ( 76 )$$

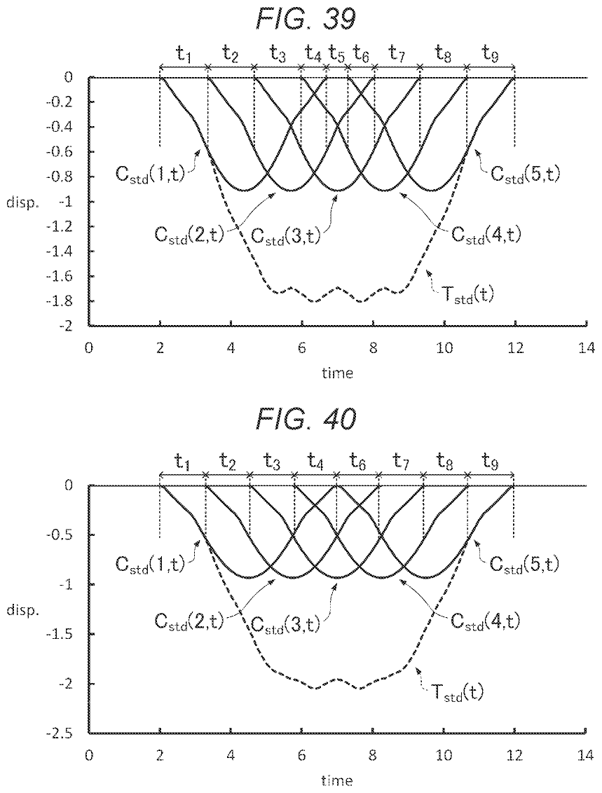

Formula (77) expresses the matrix C_{std_X} when L_{B}=70 m is set. Formula (77) shows the fact that the head vehicle is moving in the time interval t₁, the head vehicle and the 2-nd vehicle are moving in the time interval t₂, the head vehicle, the 2-nd vehicle, and the 3-rd vehicle are moving in the time interval t₃, the head vehicle, the 2-nd vehicle, the 3-rd vehicle, and the 4-th vehicle are moving in the time interval t₄, the 2-nd vehicle, the 3-rd vehicle, and the 4-th vehicle are moving in the time interval t₅, the 2-nd vehicle, the 3-rd vehicle, the 4-th vehicle, and the rearmost vehicle are moving in the time interval t₆, the 3-rd vehicle, the 4-th vehicle, and the rearmost vehicle are moving in the time interval t₇, the 4-th vehicle and the rearmost vehicle are moving in the time interval t₈, and the rearmost vehicle is moving in the time interval t₉. FIG. 39 shows an example of the deflection amounts C_{std}(1,t) through C_{std}(5,t) by the respective vehicles and the deflection amount T_{std}(t) by the railroad vehicle 6 when L_{B}=70 m is set.

$${C}_{std \_ X} = ( \begin{matrix}1 & 0 & 0 & 0 & 0 \\ 1 & 1 & 0 & 0 & 0 \\ 1 & 1 & 1 & 0 & 0 \\ 1 & 1 & 1 & 1 & 0 \\ 0 & 1 & 1 & 1 & 0 \\ 0 & 1 & 1 & 1 & 1 \\ 0 & 0 & 1 & 1 & 1 \\ 0 & 0 & 0 & 1 & 1 \\ 0 & 0 & 0 & 0 & 1\end{matrix} ) \qquad ( 77 )$$

Formula (78) expresses the matrix C_{std_X} when L_{B}=80 m is set. Formula (78) shows the fact that the head vehicle is moving in the time interval t₁, the head vehicle and the 2-nd vehicle are moving in the time interval t₂, the head vehicle, the 2-nd vehicle, and the 3-rd vehicle are moving in the time interval t₃, the head vehicle, the 2-nd vehicle, the 3-rd vehicle, and the 4-th vehicle are moving in the time interval t₄, the 2-nd vehicle, the 3-rd vehicle, the 4-th vehicle, and the rearmost vehicle are moving in the time interval t₆, the 3-rd vehicle, the 4-th vehicle, and the rearmost vehicle are moving in the time interval t₇, the 4-th vehicle and the rearmost vehicle are moving in the time interval t₅, and the rearmost vehicle is moving in the time interval t₉. Further, Formula (76) shows the fact that the time interval t₅ does not exist since the time tsort(5) and the time tsort(6) are equal to each other. FIG. 40 shows an example of the deflection amounts C_{std}(1,t) through C_{std}(5,t) by the respective vehicles and the deflection amount T_{std}(t) by the railroad vehicle 6 when

$${C}_{std \_ X} = ( \begin{matrix}1 & 0 & 0 & 0 & 0 \\ 1 & 1 & 0 & 0 & 0 \\ 1 & 1 & 1 & 0 & 0 \\ 1 & 1 & 1 & 1 & 0 \\ 0 & 0 & 0 & 0 & 0 \\ 0 & 1 & 1 & 1 & 1 \\ 0 & 0 & 1 & 1 & 1 \\ 0 & 0 & 0 & 1 & 1 \\ 0 & 0 & 0 & 0 & 1\end{matrix} ) \qquad ( 78 )$$

The pattern of the matrix C_{std_X} changes as expressed in Formula (72) through Formula (78) in accordance with the relationship between the length L_{B} of the upper structure 7 and the dimensions of the railroad vehicle 6, and the situation in which the vehicles of the railroad vehicle 6 move on the upper structure 7 is figured out using the matrix C_{std_X} thus calculated.

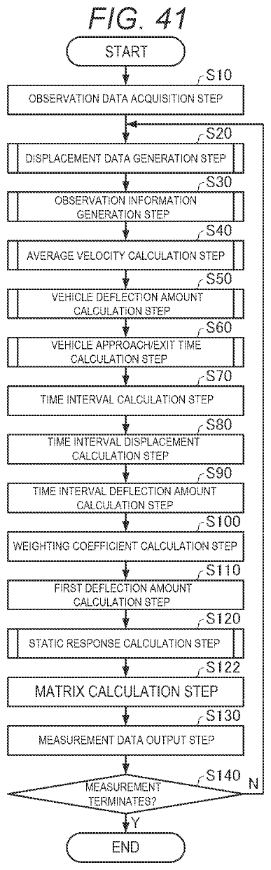

FIG. 41 is a flowchart showing an example of a procedure of a measurement method according to the second embodiment. In FIG. 41, the steps of performing substantially the same processing as in the steps shown in FIG. 25 are denoted by the same reference symbols. In the present embodiment, the measurement device 1 executes the procedure shown in FIG. 41.

As shown in FIG. 41, first, the measurement device 1 performs the processing in the steps S10 through S120 similarly to the first embodiment.

Then, in a matrix calculation step S122, the measurement device 1 calculates the matrix C_{std_X} representing whether the vehicles are moving on the upper structure 7 in the time intervals t₁ through t_{2CT-1} based on the deflection amount C_{std}(Cₘ,t) of the upper structure 7 by the vehicles in the time intervals t₁ through t_{2CT-1} calculated in the time interval calculation step S70. Specifically, the measurement device 1 calculates the matrix C_{std_X} using Formula (69) and Formula (70) described above.

Then, similarly to the first embodiment, the measurement device 1 performs the processing in the measurement data output step S130. It should be noted that the measurement data output by the measurement device 1 can include the displacement data u(t) generated in the step S20, the deflection amount T_{p_std}(t) calculated in the step S110, the matrix C_{std_X} calculated in the step S122, and so on in addition to the weighting coefficients P_{C}_{ₘ} calculated in the step S100 and the deflection amount T_{p_EOstd}(t) calculated in the step S120.

Then, the measurement device 1 repeatedly performs the processing in the steps S10 through S130 until the measurement is completed in the step S140.

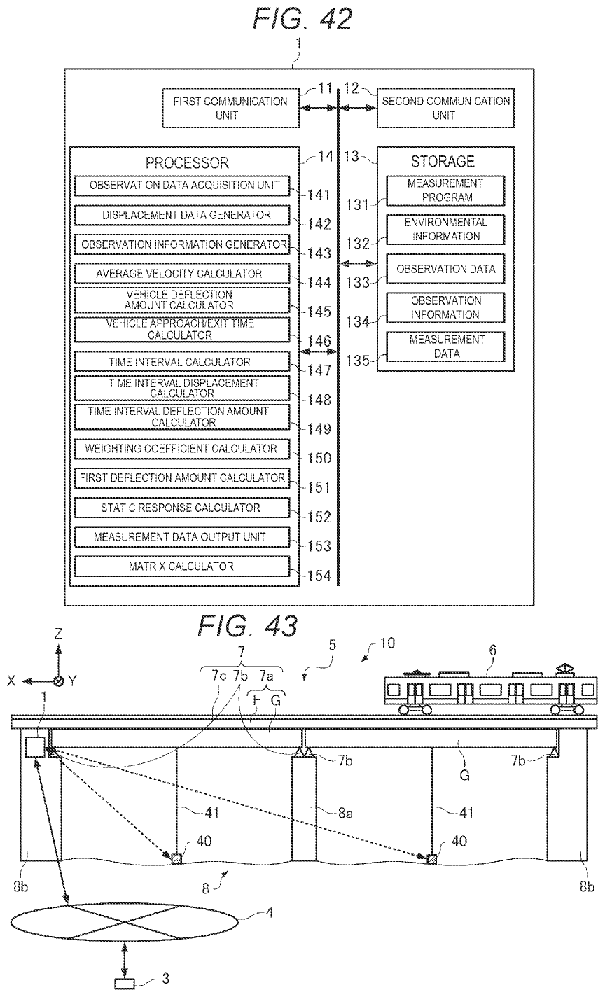

FIG. 42 is a diagram showing a configuration example of the measurement device 1 according to the second embodiment. As shown in FIG. 42, the measurement device 1 according to the second embodiment is provided with the first communication unit 11, the second communication unit 12, the storage 13, and the processor 14 similarly to the first embodiment. The functions of the first communication unit 11, the second communication unit 12, and the storage 13 are substantially the same as those in the first embodiment, and therefore, the description thereof will be omitted.

In the present embodiment, the processor 14 executes a measurement program 131 stored in the storage 13 to thereby function as the observation data acquisition unit 141, the displacement data generator 142, the observation information generator 143, the average velocity calculator 144, the vehicle deflection amount calculator 145, the vehicle approach/exit time calculator 146, the time interval calculator 147, the time interval displacement calculator 148, the time interval deflection amount calculator 149, the weighting coefficient calculator 150, the first deflection amount calculator 151, the static response calculator 152, the measurement data output unit 153, and a matrix calculator 154. In other words, the processor 14 includes the observation data acquisition unit 141, the displacement data generator 142, the observation information generator 143, the average velocity calculator 144, the vehicle deflection amount calculator 145, the vehicle approach/exit time calculator 146, the time interval calculator 147, the time interval displacement calculator 148, the time interval deflection amount calculator 149, the weighting coefficient calculator 150, the first deflection amount calculator 151, the static response calculator 152, the measurement data output unit 153, and the matrix calculator 154.

The functions of the processor 14 includes the observation data acquisition unit 141, the displacement data generator 142, the observation information generator 143, the average velocity calculator 144, the vehicle deflection amount calculator 145, the vehicle approach/exit time calculator 146, the time interval calculator 147, the time interval displacement calculator 148, the time interval deflection amount calculator 149, the weighting coefficient calculator 150, the first deflection amount calculator 151, the static response calculator 152, and the measurement data output unit 153 are substantially the same as those in the first embodiment, and therefore, the description thereof will be omitted. It should be noted that the observation data acquisition unit 141 performs the processing in the observation data acquisition step S10 in FIG. 41. Further, the displacement data generator 142 performs the processing in the displacement data generation step S20 in FIG. 41. Further, the observation information generator 143 performs the processing in the observation information generation step S30 in FIG. 41. Further, the average velocity calculator 144 performs the processing in the average velocity calculation step S40 in FIG. 41. Further, the vehicle deflection amount calculator 145 performs the processing in the vehicle deflection amount calculation step S50 in FIG. 41. Further, the vehicle approach/exit time calculator 146 performs the processing in the vehicle approach/exit time calculation step S60 in FIG. 41. The time interval calculator 147 performs the processing in the time interval calculation step S70 in FIG. 41. Further, the time interval displacement calculator 148 performs the processing in the time interval displacement calculation step S80 in FIG. 41. Further, the time interval deflection amount calculator 149 performs the processing in the time interval deflection amount calculation step S90 in FIG. 41. Further, the weighting coefficient calculator 150 performs the processing in the weighting coefficient calculation step S100 in FIG. 41. Further, the first deflection amount calculator 151 performs the processing in the first deflection amount calculation step S110 in FIG. 41. Further, the static response calculator 152 performs the processing in the static response calculation step S120 in FIG. 41. Further, the measurement data output unit 153 performs the processing in the measurement data output step S130 in FIG. 41.

The matrix calculator 154 calculates the matrix C_{std_X} representing whether the vehicles are moving on the upper structure 7 in the time intervals t₁ through t_{2CT-1} based on the deflection amount C_{std}(Cₘ,t) of the upper structure 7 by the vehicles in the time intervals t₁ through t_{2CT-1} calculated by the time interval calculator 147.

Specifically, the matrix calculator 154 calculates the matrix C_{std_X} using Formula (69) and Formula (70) described above. The matrix C_{std_X} can be stored in the storage 13 as at least a part of the measurement data 135.

As described above, the measurement program 131 is a program of making the measurement device 1 as a computer execute the procedures of the flowchart shown in FIG. 41.

In the measurement method according to the second embodiment described hereinabove, the measurement device 1 calculates the matrix C_{std_X} representing whether the vehicles are moving on the upper structure 7 in the time intervals t₁ through t_{2CT-1} based on the deflection amount C_{std}(Cₘ,t) of the upper structure 7 by the vehicles in the time intervals t₁ through t_{2CT-1}. Therefore, according to the measurement method according to the second embodiment, it is possible for the measurement device 1 to calculate the matrix C_{std_X} capable of easily confirming the situation in which the vehicles of the railroad vehicle 6 move on the upper structure 7.

Besides the above, according to the measurement method related to the second embodiment, there can be exerted substantially the same advantage as that of the measurement method according to the first embodiment.

### 3. Modified Examples

The present disclosure is not limited to the present embodiments, but can be implemented with a variety of modifications within the scope or the spirit of the present disclosure.

The sensor 2 as the observation device is the acceleration sensor for outputting the acceleration data a(k) in the embodiments described above, but the observation device is not limited to the acceleration sensor. For example, the observation device can be an impact sensor, a pressure sensor, a strain indicator, an image measurement device, a load cell, or a displacement gauge.

The impact sensor detects impact acceleration as a response to an action on the observation point R of each of the vehicles of the railroad vehicle 6. The pressure sensor, the strain indicator, and the load cell detect a stress change as a response to an action on the observation point R of each of the vehicles of the railroad vehicle 6. The image measurement device detects a displacement as a response to an action on the observation point R of each of the vehicles of the railroad vehicle 6 using image processing. The displacement gauge is, for example, a contact-type displacement gauge, a ring-type displacement gauge, a laser displacement gauge, or a displacement measurement instrument using a pressure sensor or an optical fiber, and detects the displacement as a response to an action on the observation point R of each of the vehicles of the railroad vehicle 6.

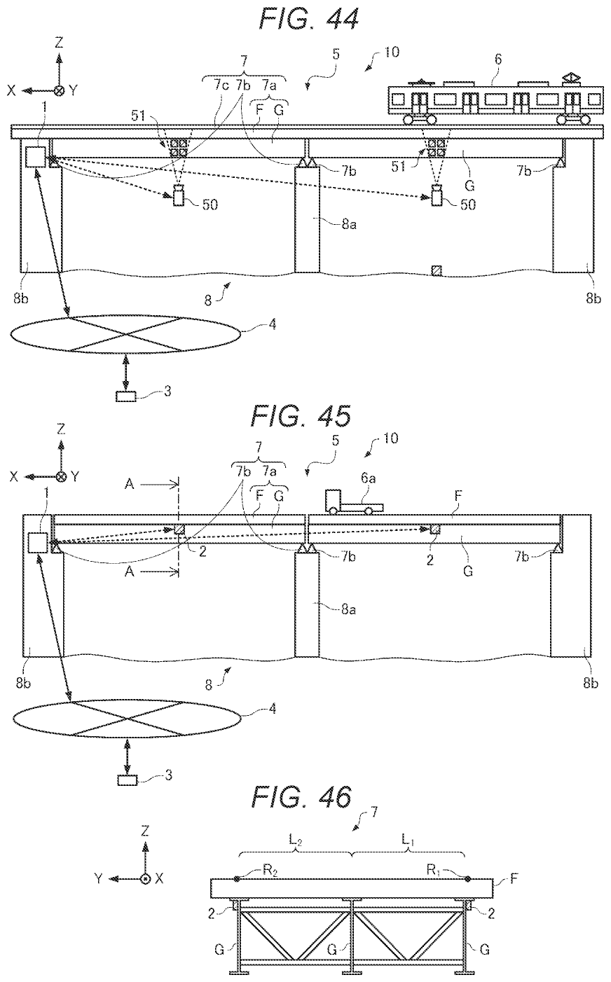

As an example, FIG. 43 shows a configuration example of a measurement system 10 using the ring-type displacement gauge as the observation device. Further, FIG. 44 shows a configuration example of the measurement system 10 using the image measurement device as the observation device. In FIG. 43 and FIG. 44, the same constituents as those shown in FIG. 1 are denoted by the same reference symbols, and the description thereof will be omitted. In the measurement system 10 shown in FIG. 43, a piano wire 41 is fixed between an upper surface of the ring-type displacement gauge 40 and a lower surface of the main beam G located immediately above the ring-type displacement gauge 40, and the ring-type displacement gauge 40 measures the displacement of the piano wire 41 due to the deflection of the upper structure 7, and then transmits the displacement data thus measured to the measurement device 1. The measurement device 1 generates the measurement data 135 based on the displacement data transmitted from the ring-type displacement gauge 40. Further, in the measurement system 10 shown in FIG. 44, a camera 50 transmits the image obtained by imaging a target 51 disposed on a side surface of the main beam G to the measurement device 1. The measurement device 1 processes the image transmitted from the camera 50, then calculates the displacement of the target 51 due to the deflection of the upper structure 7 to generate the displacement data, and then generates the measurement data 135 based on the displacement data thus generated. Although the measurement device 1 generates the displacement data as the image measurement device in the example shown in FIG. 44, it is possible for an image measurement device not shown different from the measurement device 1 to generate the displacement data using image processing.

Further, although the bridge 5 is the railroad bridge, and the moving object moving on the bridge 5 is the railroad vehicle 6 in the embodiments described above, it is possible to assume that the bridge 5 is a road bridge, and the moving object moving on the bridge 5 is a vehicle such as a car, a streetcar, a cargo truck, or a construction vehicle. FIG. 45 shows a configuration example of the measurement system 10 when the bridge 5 is the road bridge, and a vehicle 6a moves on the bridge 5. In FIG. 45, the same constituents as those shown in FIG. 1 are denoted by the same reference symbols. As shown in FIG. 45, the bridge 5 as the road bridge is constituted by the upper structure 7 and the lower structure 8 similarly to the railroad bridge. FIG. 46 is a cross-sectional view of the upper structure 7 cut along the line A-A shown in FIG. 45. As shown in FIG. 45 and FIG. 46, the upper structure 7 includes the bridge floor 7a constituted by the floor plate F, the main beams G, the side beams not shown, and so on, and the shoes 7b. Further, as shown in FIG. 45, the lower structure 8 includes the bridge legs 8a and the bridge abutments 8b. The upper structure 7 is a structure bridged between any one of pairs of the bridge abutment 8b and the bridge leg 8a adjacent to each other, the bridge abutments 8b adjacent to each other, and the bridge legs 8a adjacent to each other. The both end portions of the upper structure 7 are located at the positions of the bridge abutment 8b and the bridge leg 8a adjacent to each other, the positions of the two bridge abutments 8b adjacent to each other, or the positions of the two bridge legs 8a adjacent to each other. The bridge 5 is, for example, a steel bridge, a beam bridge, or an RC bridge.

The sensors 2 are each installed in the central portion in the longitudinal direction of the upper structure 7, specifically the central portion in the longitudinal direction of the main beam G. It should be noted that it is sufficient for each of the sensors 2 to be able to detect the acceleration for calculating the displacement of the upper structure 7, and the installation position is not limited to the central portion of the upper structure 7. It should be noted that when each of the sensors 2 is installed on the floor plate F of the upper structure 7, there is a possibility that the sensor 2 is broken due to running of the vehicle 6a, and further, there is a possibility that the measurement accuracy is affected by a local deformation of the bridge floor 7a, and therefore, in the example shown in FIG. 45 and FIG. 46, each of the sensors 2 is provided to the main beam G of the upper structure 7.

As shown in FIG. 46, the upper structure 7 has two lanes L₁, L₂ on which the vehicle 6a as the moving object can move, and the three main beams G. In the example shown in FIG. 45 and FIG. 46, in the central portion in the longitudinal direction of the upper structure 7, the sensors 2 are provided respectively to the two main beams located at the both ends, wherein an observation point R₁ is disposed at a position on the surface of the lane L₁ located vertically above one of the sensors 2, and an observation point R₂ is disposed at a position on the surface of the lane L₂ located vertically above the other of the sensors 2. In other words, the two sensors 2 are observation devices for observing the observation points R₁, R₂, respectively. It is sufficient for the two sensors 2 for respectively observing the observation points R₁, R₂ to be disposed at positions where the sensors 2 can detect the acceleration occurring at the observation points R₁, R₂ due to the running of the vehicle 6a, but it is desirable for the sensors 2 to be disposed at positions close to the observation points R₁, R₂. It should be noted that the number and the installation positions of the sensors 2 and the number of the lanes are not limited to those in the example shown in FIG. 45 and FIG. 46, and a variety of modified implementations can be made.

The measurement device 1 calculates the displacements due to the deflections of the lanes L₁, L₂ by the running of the vehicle 6a based on the acceleration data output from the sensors 2, and then transmits the information of the displacements of the lanes L₁, L₂ to the monitoring device 3 via the communication network 4. It is possible for the monitoring device 3 to store that information in a storage device not shown, and perform processing such as monitoring of the vehicle 6a and a failure determination of the upper structure 7 based on that information.

Further, the sensors 2 are each provided to the main beam G of the upper structure 7 in the embodiments described above, but can be disposed on the surface or the inside of the upper structure 7, on the lower surface of the floor plate F, in the bridge leg 8a, or the like. Further, in the embodiments described above, the upper structure of the bridge is cited as an example of the structural object, but this is not a limitation, and it is sufficient for the structural object to be what is deformed by a movement of a moving object.

Further, the measurement device 1 calculates the approach time tᵢ based on the observation data output from the observation device for observing the observation point R in the embodiments described above, but can calculate the approach time tᵢ based on the observation data output from another observation device for observing the approach end of the upper structure 7. Similarly, the measurement device 1 calculates the exit time tₒ based on the observation data output from the observation device for observing the observation point R in the embodiments described above, but can calculate the exit time tₒ based on the observation data output from another observation device for observing the exit end of the upper structure 7.

The embodiments and the modified examples described above are illustrative only, and the present disclosure is not limited to the embodiments and the modified examples. For example, it is also possible to arbitrarily combine any of the embodiments and the modified examples with each other.

The present disclosure includes configurations substantially the same as the configuration described as the embodiment such as configurations having the same function, the same way, and the same result, or configurations having the same object and the same advantage. Further, the present disclosure includes configurations obtained by replacing a non-essential part of the configuration described as the embodiment. Further, the present disclosure includes configurations providing the same functions and advantages, and configurations capable of achieving the same object as those of the configuration described as the embodiment. Further, the present disclosure includes configurations obtained by adding a known technology to the configuration described as the embodiment.

The following contents derive from the embodiments and the modified examples described above.

A measurement method according to an aspect of the present disclosure includes a displacement data generation step of generating first displacement data based on a physical quantity as a response to an action on observation points in a plurality of regions of a moving object moving on a structural object based on data output from an observation device configured to observe the observation points of the structural object, an observation information generation step of generating observation information including an approach time and an exit time of the moving object with respect to the structural object, a vehicle deflection amount calculation step of calculating a deflection amount of the structural object by vehicles of the moving object based on an approximation formula of a deflection of the structural object, the observation information, and environmental information including a dimension of the moving object and a dimension of the structural object generated in advance, a vehicle approach/exit time calculation step of calculating an approach time and an exit time of each of the vehicles of the moving object with respect to the structural object based on the observation information and the environmental information, a time interval calculation step of calculating time intervals divided by a plurality of times obtained by sorting the approach times and the exit times of the vehicles with respect to the structural object by time, a time interval displacement calculation step of calculating an amplitude amount of the first displacement data in each of the time intervals, a time interval deflection amount calculation step of calculating an amplitude amount of the deflection amount of the structural object by each of the vehicles in each of the time intervals, and a weighting coefficient calculation step of calculating weighting coefficients to the respective vehicles assuming that a sum of products of the amplitude amounts of the deflection amounts of the structural object by the vehicles in the time intervals and the weighting coefficients to the vehicles is equal to the amplitude amount of the first displacement data in the respective time intervals.

In this measurement method, the weighting coefficients as the coefficients correlated with the weights of the vehicles of the moving object moving on the structural object are calculated with relatively simple processing using the first displacement data generated based on the observation data and the deflection amount of the structural object by each of the vehicles of the moving object generated based on the approximation formula of the deflection of the structural object. Therefore, according to this measurement method, it is possible to calculate the weighting coefficients to the respective vehicles with the processing relatively small in calculation amount without performing the processing extremely large in calculation amount such as estimating unknown parameters of a theoretical analysis model from the acceleration data using the inverse analysis method.

Further, according to this measurement method, by assuming that the sum of the products of the amplitude amounts of the deflection amounts of the structural object by the vehicles in the time intervals and the weighting coefficients to the vehicles is equal to the amplitude amount of the first displacement data in the time intervals, it is possible to accurately calculate the weighting coefficient corresponding to the weight of each of the vehicles.

In the measurement method according to the aspect described above, the amplitude amount may be an average value or an integrated value.

The measurement method according to the aspect described above may further include a first deflection amount calculation step of calculating a first deflection amount of the structural object by the moving object using a sum of products of the weighting coefficients to the vehicles and the deflection amounts of the structural object by the vehicles.

According to this measurement method, it is possible to calculate the deflection amount of the structural object when the moving object moves on the structural object with the processing relatively small in calculation amount. Further, according to this measurement method, it is possible to accurately calculate the deflection amount of the structural object when the moving object moves on the structural object not using the same coefficient to all of the vehicles but using the weighting coefficients corresponding to the loads by the respective vehicles.

The measurement method according to the aspect described above may further include a static response calculation step of calculating a static response when the moving object moves on the structural object based on the first displacement data and the first deflection amount.

According to this measurement method, it is possible to accurately calculate the static response when the moving object moves on the structural object with the processing relatively small in calculation amount.

In the measurement method according to the aspect described above, the static response calculation step may include performing filter processing on the first displacement data to calculate second displacement data reduced in vibration component, performing filter processing on the first deflection amount to calculate second deflection amount reduced in vibration component, approximating the second displacement data with a linear function of the second deflection amount to calculate a coefficient of a linear term and a constant term of the linear function, calculating a third deflection amount based on the coefficient of the linear term, the constant term, and the second deflection amount, calculating an offset based on the constant term, the second deflection amount, and the third deflection amount, and adding a product of the coefficient of the linear term and the first deflection amount to the offset to calculate the static response.

According to this measurement method, by approximating the second displacement data in which the vibration component included in the first displacement data is reduced with the linear function of the second deflection amount in which the vibration component included in the first deflection amount is reduced, the calculation accuracy of the coefficient of the linear term and the constant term of the linear function increases. Further, since the product of the coefficient of the linear term and the first deflection amount corresponds to the displacement of the structural object proportional to the load by the moving object, and the offset corresponds to the displacement which is not proportional to the load by the moving object, such as a play or floating of the structural object, according to this measurement method, by adding the product of the coefficient of the linear term and the first deflection amount to the offset, it is possible to accurately calculate the static response.

The measurement method according to the aspect described above may further include a matrix calculation step of calculating a matrix representing whether the vehicles are moving on the structural object in the time intervals based on deflection amounts of the structural object by the vehicles in the time intervals.

According to this measurement method, it is possible to calculate the matrix with which the situation in which the vehicles of the moving object move on the structural object can easily be confirmed.

In the measurement method according to the aspect described above, the structural object may be an upper structure of a bridge.

According to this measurement method, it is possible to accurately calculate the weighting coefficients corresponding to the weights of the respective vehicles of the moving object with the processing relatively small in calculation amount.

In the measurement method according to the aspect described above, the moving object may be a railroad vehicle.

According to this measurement method, it is possible to accurately calculate the weighting coefficients corresponding to the weights of the respective vehicles of the moving object with the processing relatively small in calculation amount.

In the measurement method according to the aspect described above, the approximation formula of the deflection of the structural object may be a formula based on a structural model of the structural object.

According to this measurement method, it is possible to calculate the deflection amounts by the respective vehicles reflecting the structure of the structural object on which the moving object moves to thereby accurately calculate the weighting coefficients corresponding to the weights of the respective vehicles of the moving object.

In the measurement method according to the aspect described above, the structural model may be a simple beam supported at both ends.

According to this measurement method, it is possible to accurately calculate the weighting coefficients corresponding to the weights of the respective vehicles of the moving object which moves on the structural object similar in structure to the simple beam.

In the measurement method according to the aspect described above, the observation device may be an acceleration sensor, an impact sensor, a pressure sensor, a strain indicator, an image measurement device, a load cell, or a displacement gauge.

According to this measurement method, it is possible to accurately measure the weighting coefficients corresponding to the weights of the respective vehicles of the moving object using data of acceleration, a stress change, or a displacement.

In the measurement method according to the aspect described above, the structural object may have a structure in which BWIM (Bridge Weigh in Motion) works.

A measurement device according to an aspect of the present disclosure includes a displacement data generator configured to generate first displacement data based on a physical quantity as a response to an action on observation points in a plurality of regions of a moving object moving on a structural object based on data output from an observation device configured to observe the observation points of the structural object, an observation information generator configured to generate observation information including an approach time and an exit time of the moving object with respect to the structural object, a vehicle deflection amount calculator configured to calculate a deflection amount of the structural object by vehicles of the moving object based on an approximation formula of a deflection of the structural object, the observation information, and environmental information including a dimension of the moving object and a dimension of the structural object generated in advance, a vehicle approach/exit time calculator configured to calculate an approach time and an exit time of each of the vehicles of the moving object with respect to the structural object based on the observation information and the environmental information, a time interval calculator configured to calculate time intervals divided by a plurality of times obtained by sorting the approach times and the exit times of the vehicles with respect to the structural object by time, a time interval displacement calculator configured to calculate an amplitude amount of the first displacement data in each of the time intervals, a time interval deflection amount calculator configured to calculate an amplitude amount of the deflection amount of the structural object by each of the vehicles in each of the time intervals, and a weighting coefficient calculator configured to calculate weighting coefficients to the respective vehicles assuming that a sum of products of the amplitude amounts of the deflection amounts of the structural object by the vehicles in the time intervals and the weighting coefficients to the vehicles is equal to the amplitude amount of the first displacement data in the respective time intervals.

The present measurement device calculates the deflection amount of the structural object when the moving object moves on the structural object with the relatively simple processing using the first displacement data generated based on the observation data, and the first deflection amount generated based on the approximation formula of the deflection of the structural object. Therefore, according to this measurement device, it is possible to calculate the deflection amount of the structural object when the moving object moves on the structural object using the processing relatively small in calculation amount without performing the processing extremely large in calculation amount such as estimating unknown parameters of a theoretical analysis model from the acceleration data using the inverse analysis method.

Further, this measurement device calculates the time interval in which each of the vehicles of the moving object moves alone on the structural object, calculates the displacement response and the deflection response when each of the vehicles moves alone on the structural object, calculates the weighting coefficients to the respective vehicles based on the displacement response and the deflection response in the time interval in which each of the vehicles moves alone on the structural object, and calculates the second deflection amount obtained by correcting the first deflection amount based on the weighting coefficients to the respective vehicles. Therefore, according to this measurement device, it is possible to accurately calculate the deflection amount of the structural object when the moving object moves on the structural object not using the same coefficient to all of the vehicles but using the weighting coefficients corresponding to the loads by the respective vehicles.

In this measurement device, the weighting coefficients as the coefficients correlated with the weights of the vehicles of the moving object moving on the structural object are calculated with relatively simple processing using the first displacement data generated based on the observation data and the deflection amount of the structural object by each of the vehicles of the moving object generated based on the approximation formula of the deflection of the structural object. Therefore, according to this measurement device, it is possible to calculate the weighting coefficients to the respective vehicles with the processing relatively small in calculation amount without performing the processing extremely large in calculation amount such as estimating unknown parameters of a theoretical analysis model from the acceleration data using the inverse analysis method.

Further, according to this measurement device, by assuming that the sum of the products of the amplitude amounts of the deflection amounts of the structural object by the vehicles in the time intervals and the weighting coefficients to the vehicles is equal to the amplitude amount of the first displacement data in the time intervals, it is possible to accurately calculate the weighting coefficient corresponding to the weight of each of the vehicles.

A measurement system according to an aspect of the present disclosure includes the measurement device according to the aspect, and the observation device configured to observe the observation points.

A non-transitory computer-readable storage medium storing a measurement program according to an aspect of the present disclosure makes a computer execute a displacement data generation step of generating first displacement data based on a physical quantity as a response to an action on observation points in a plurality of regions of a moving object moving on a structural object based on data output from an observation device configured to observe the observation points of the structural object, an observation information generation step of generating observation information including an approach time and an exit time of the moving object with respect to the structural object, a vehicle deflection amount calculation step of calculating a deflection amount of the structural object by vehicles of the moving object based on an approximation formula of a deflection of the structural object, the observation information, and environmental information including a dimension of the moving object and a dimension of the structural object generated in advance, a vehicle approach/exit time calculation step of calculating an approach time and an exit time of each of the vehicles of the moving object with respect to the structural object based on the observation information and the environmental information, a time interval calculation step of calculating time intervals divided by a plurality of times obtained by sorting the approach times and the exit times of the vehicles with respect to the structural object by time, a time interval displacement calculation step of calculating an amplitude amount of the first displacement data in each of the time intervals, a time interval deflection amount calculation step of calculating an amplitude amount of the deflection amount of the structural object by each of the vehicles in each of the time intervals, and a weighting coefficient calculation step of calculating weighting coefficients to the respective vehicles assuming that a sum of products of the amplitude amounts of the deflection amounts of the structural object by the vehicles in the time intervals and the weighting coefficients to the vehicles is equal to the amplitude amount of the first displacement data in the respective time intervals.

In this measurement program, the weighting coefficients as the coefficients correlated with the weights of the vehicles of the moving object moving on the structural object are calculated with relatively simple processing using the first displacement data generated based on the observation data and the deflection amount of the structural object by each of the vehicles of the moving object generated based on the approximation formula of the deflection of the structural object. Therefore, according to this measurement program, it is possible to calculate the weighting coefficients to the respective vehicles with the processing relatively small in calculation amount without performing the processing extremely large in calculation amount such as estimating unknown parameters of a theoretical analysis model from the acceleration data using the inverse analysis method.

Further, according to this measurement program, by assuming that the sum of the products of the amplitude amounts of the deflection amounts of the structural object by the vehicles in the time intervals and the weighting coefficients to the vehicles is equal to the amplitude amount of the first displacement data in the time intervals, it is possible to accurately calculate the weighting coefficient corresponding to the weight of each of the

What is claimed is:

1. A measurement method comprising:
a displacement data generation step of generating first displacement data based on a physical quantity as a response to an action on observation points in a plurality of regions of a moving object moving on a structural object based on data output from an observation device configured to observe the observation points of the structural object;
an observation information generation step of generating observation information including an approach time and an exit time of the moving object with respect to the structural object;
a vehicle deflection amount calculation step of calculating a deflection amount of the structural object by vehicles of the moving object based on an approximation formula of a deflection of the structural object, the observation information, and environmental information including a dimension of the moving object and a dimension of the structural object generated in advance;
a vehicle approach/exit time calculation step of calculating an approach time and an exit time of each of the vehicles of the moving object with respect to the structural object based on the observation information and the environmental information;
a time interval calculation step of calculating time intervals divided by a plurality of times obtained by sorting the approach times and the exit times of the vehicles with respect to the structural object by time;
a time interval displacement calculation step of calculating an amplitude amount of the first displacement data in each of the time intervals;
a time interval deflection amount calculation step of calculating an amplitude amount of the deflection amount of the structural object by each of the vehicles in each of the time intervals; and
a weighting coefficient calculation step of calculating weighting coefficients to the respective vehicles assuming that a sum of products of the amplitude amounts of the deflection amounts of the structural object by the vehicles in the time intervals and the weighting coefficients to the vehicles is equal to the amplitude amount of the first displacement data in the respective time intervals.

2. The measurement method according to claim 1, wherein
the amplitude amount is an average value or an integrated value.

3. The measurement method according to claim 1, further comprising:
a first deflection amount calculation step of calculating a first deflection amount of the structural object by the moving object using a sum of products of the weighting coefficients to the vehicles and the deflection amounts of the structural object by the vehicles.

4. The measurement method according to claim 3, further comprising:
a static response calculation step of calculating a static response when the moving object moves on the structural object based on the first displacement data and the first deflection amount.

5. The measurement method according to claim 4, wherein
the static response calculation step includes
performing filter processing on the first displacement data to calculate second displacement data reduced in vibration component,
performing filter processing on the first deflection amount to calculate a second deflection amount reduced in vibration component,
approximating the second displacement data with a linear function of the second deflection amount to calculate a coefficient of a linear term and a constant term of the linear function,
calculating a third deflection amount based on the coefficient of the linear term, the constant term, and the second deflection amount,
calculating an offset based on the constant term, the second deflection amount, and the third deflection amount, and
adding a product of the coefficient of the linear term and the first deflection amount to the offset to calculate the static response.

6. The measurement method according to claim 1, further comprising:
a matrix calculation step of calculating a matrix representing whether the vehicles are moving on the structural object in the time intervals based on deflection amounts of the structural object by the vehicles in the time intervals.

7. The measurement method according to claim 1, wherein
the structural object is an upper structure of a bridge.

8. The measurement method according to claim 1, wherein
the moving object is a railroad vehicle.

9. The measurement method according to claim 1, wherein
the approximation formula of the deflection of the structural object is a formula based on a structural model of the structural object.

10. The measurement method according to claim 9, wherein
the structural model is a simple beam supported at both ends.

11. The measurement method according to claim 1, wherein
the observation device is an acceleration sensor, an impact sensor, a pressure sensor, a strain indicator, an image measurement device, a load cell, or a displacement gauge.

12. The measurement method according to claim 1, wherein
the structural object has a structure in which BWIM (Bridge Weigh in Motion) works.

13. A measurement device comprising:
a displacement data generator configured to generate first displacement data based on a physical quantity as a response to an action on observation points in a plurality of regions of a moving object moving on a structural object based on data output from an observation device configured to observe the observation points of the structural object;
an observation information generator configured to generate observation information including an approach time and an exit time of the moving object with respect to the structural object;
a vehicle deflection amount calculator configured to calculate a deflection amount of the structural object by vehicles of the moving object based on an approximation formula of a deflection of the structural object, the observation information, and environmental information including a dimension of the moving object and a dimension of the structural object generated in advance;
a vehicle approach/exit time calculator configured to calculate an approach time and an exit time of each of the vehicles of the moving object with respect to the structural object based on the observation information and the environmental information;
a time interval calculator configured to calculate time intervals divided by a plurality of times obtained by sorting the approach times and the exit times of the vehicles with respect to the structural object by time;
a time interval displacement calculator configured to calculate an amplitude amount of the first displacement data in each of the time intervals;
a time interval deflection amount calculator configured to calculate an amplitude amount of the deflection amount of the structural object by each of the vehicles in each of the time intervals; and
a weighting coefficient calculator configured to calculate weighting coefficients to the respective vehicles assuming that a sum of products of the amplitude amounts of the deflection amounts of the structural object by the vehicles in the time intervals and the weighting coefficients to the vehicles is equal to the amplitude amount of the first displacement data in the respective time intervals.

14. A measurement system comprising:
the measurement device according to claim 13; and
the observation device configured to observe the observation points.

15. A non-transitory computer-readable storage medium storing a measurement program configured to make a computer execute processing comprising:
a displacement data generation step of generating first displacement data based on a physical quantity as a response to an action on observation points in a plurality of regions of a moving object moving on a structural object based on data output from an observation device configured to observe the observation points of the structural object;
an observation information generation step of generating observation information including an approach time and an exit time of the moving object with respect to the structural object;
a vehicle deflection amount calculation step of calculating a deflection amount of the structural object by vehicles of the moving object based on an approximation formula of a deflection of the structural object, the observation information, and environmental information including a dimension of the moving object and a dimension of the structural object generated in advance;
a vehicle approach/exit time calculation step of calculating an approach time and an exit time of each of the vehicles of the moving object with respect to the structural object based on the observation information and the environmental information;
a time interval calculation step of calculating time intervals divided by a plurality of times obtained by sorting the approach times and the exit times of the vehicles with respect to the structural object by time;
a time interval displacement calculation step of calculating an amplitude amount of the first displacement data in each of the time intervals;
a time interval deflection amount calculation step of calculating an amplitude amount of the deflection amount of the structural object by each of the vehicles in each of the time intervals; and
a weighting coefficient calculation step of calculating weighting coefficients to the respective vehicles assuming that a sum of products of the amplitude amounts of the deflection amounts of the structural object by the vehicles in the time intervals and the weighting coefficients to the vehicles is equal to the amplitude amount of the first displacement data in the respective time intervals.
